(19) United States
(12) Patent Application Publication
(10) Pub. No.: US 2025/0293726 A1
(43) Pub. Date: Sep. 18, 2025

(54) CONTROL UNIT, ENTITY AND METHOD FOR USE IN WIRELESS COMMUNICATIONS NETWORK

(71) Applicant: HUAWEI TECHNOLOGIES CO., LTD., Shenzhen (CN)

(72) Inventors: Mustapha AMARA, Boulogne Billancourt (FR); Melissa DUARTE GELVEZ, Boulogne Billancourt (FR); Mohamed KAMOUN, Boulogne Billancourt (FR); Sami MEKKI, Boulogne Billancourt (FR)

(21) Appl. No.: 19/222,887

(22) Filed: May 29, 2025

Related U.S. Application Data
(63) Continuation of application No. PCT/EP2022/083893, filed on Nov. 30, 2022.

(51) Int. Cl. H04B 1/56

(52) U.S. Cl. CPC H04B 1/56

(57) ABSTRACT

A control unit for use in a wireless communication network, the network including a full duplex node and one or more digitally controllable scatterers, said full duplex node including a transmitter unit and a receiver unit. The control unit includes an assessing unit for identifying an initial set of potential digitally controllable scatterers to be used in the communication, and assessing a level of resulting residual self-interference for one or more potential configurations of the digitally controllable scatterer. The control unit includes an identifying unit for identifying a subset dᵢ of the initial set of digitally controllable scatterers to be associated with the full duplex node and a digitally controllable scatterers control unit for providing information required for configuring the digitally controllable scatterers in the subset dᵢ.

### CROSS-REFERENCE TO RELATED APPLICATIONS

This application is a continuation of International Application No. PCT/EP2022/083893, filed on Nov. 30, 2022, the disclosure of which is hereby incorporated by reference in its entirety.

### TECHNICAL FIELD

The present disclosure relates generally to the field of full duplex communication; and more specifically, to a control unit, an entity comprising the control unit and a method for use in a wireless communications network.

### BACKGROUND

Generally, a full-duplex (FD) communication node is designed to transmit as well as receive the data simultaneously. The FD node utilizes the same time and same frequency resource units for signal transmission and reception and proximity of its transmitter (TX) and receiver (RX) antennas generate a high-powered self-interference (SI) signal at the receiver antennas of the FD node, which shadows an incoming signal-of-interest (SoI) at the FD node coming from a remote transmitter. Alternatively stated, the signal reception at the FD node is degraded due to the high-powered SI signal that arises due to coupling between transmitter and the receiver units of the FD node. Reducing the TX power of the FD node can reduce the SI but this also lowers the power of the incoming SoI at the FD node's intended receiver. Various solutions have been proposed in order to mitigate the degradation of the incoming SoI due to the presence of SI. The proposed solutions are divided in three categories namely, propagation domain mitigation, analog cancellation and digital cancellation. The objective in all three types of the solutions is to mitigate the SI signal so that the SI power at the receiver of the FD node can be reduced. A typical FD node implementation includes a first stage of propagation domain mitigation followed by a second stage of analog cancellation and a final third stage of digital cancellation. The residual SI after propagation domain SI mitigation corresponds to the SI that is present before the analog cancellation stage at the FD node (or before analog-to-digital conversion (ADC) if there is no analog cancellation stage at the FD node). The propagation domain SI mitigation is required for an efficient design of the FD node since it is always required in order to avoid any damage to the receiver's low noise amplifier (LNA) and it further alleviates the requirements and/or constraints on later mitigation or cancellation stages.

Currently, certain attempts have been made in order to provide the propagation domain SI mitigation, for example isolation techniques. The isolation techniques are implemented by use of a separate antenna architecture for the transmitter and receiver of the FD node. However, certain limitations are associated with the isolation techniques, such as the required antenna placement may not be feasible due to form factor constraints of the FD node. Moreover, the isolation is not effective in a multipath environment because the received SI has components due to reflections from surrounding objects and extension to multiple antenna systems is difficult. An alternative to the isolation techniques that has been also considered for propagation domain SI mitigation is transmitter beamforming. In the transmitter beamforming, the signal transmitted by the FD node is steered away from the FD node's receiver antennas. However, the transmitter beamforming and other solutions that exploit antenna directionality result in reduction of coverage area of the FD node. The reason being there are some regions where these solutions cannot be used, hence coverage area cannot be ensured. Thus, there exists a technical problem of degradation of the incoming signal-of-interest due to self-interference as well as reduced coverage area of the FD node.

Therefore, in light of the foregoing discussion, there exists a need to overcome the aforementioned drawbacks associated with the conventional methods of mitigating the self-interference at the FD node.

### SUMMARY

The present disclosure provides a control unit, an entity comprising the control unit and a method for use in a wireless communications network. The present disclosure provides a solution to the existing problem of degradation of the incoming signal-of-interest due to self-interference as well as reduced coverage area of the FD node. An aim of the present disclosure is to provide a solution that overcomes at least partially the problems encountered in prior art, and provide an improved control unit, an improved entity comprising the improved control unit and an improved method for use in a wireless communications network.

The object of the present disclosure is achieved by the solutions provided in the enclosed independent claims. Advantageous implementations of the present disclosure are further defined in the dependent claims.

In one aspect, the present disclosure provides a control unit for use in a wireless communication network. The network includes a full duplex node and one or more digitally controllable scatterers, said full duplex node includes a transmitter unit and a receiver unit. The transmitter unit and the receiver unit are coupled in such a way that a transmitted signal will generate a residual self-interference at the receiver unit. The control unit comprises an assessing unit for identifying an initial set of potential digitally controllable scatterers to be used in the communication, and for one or more digitally controllable scatterers in the initial set, assessing a level of the resulting residual self-interference for one or more potential configurations of the digitally controllable scatterer, each potential configuration including one or more digitally controllable scatterers, or being an empty set. The control unit further comprises an identifying unit for identifying a subset dᵢ of the initial set of digitally controllable scatterers to be associated with the full duplex node i, based on the assessments of residual self-interference levels for the one or more potential configurations, and a digitally controllable scatterers control unit for providing information required for configuring the digitally controllable scatterers in the subset dᵢ.

The disclosed control unit significantly reduces the coupling between the transmitter unit and the receiver unit of the full duplex node resulting in a reduced residual self-interference at the full duplex node, by virtue of using the one or more digitally controllable scatterers. And therefore, reduces the degradation of the incoming signal-of-interest at the receiver unit of the full duplex node occurring due to the residual self-interference. The control unit also increases the coverage area of the full duplex node by use of the one or more digitally controllable scatterers. Moreover, the control unit reduces the channel estimation overhead by narrowing the initial set of digitally controllable scatterers to be associated with the full duplex node by exploiting the effect of DCS choice and programming on the residual self-interference levels.

In an implementation form, the control unit further comprises a first computing unit for computing a phase response ϕ_{d} for each digitally controllable scatterer d, in the subset dᵢ, taking into account a constraint defined for a target residual self-interference level at the receiver unit. The control unit further comprises a second computing unit for computing transmitter and receiver beamformers at the full duplex node taking into account the computed phase response of each digitally controllable scatterer in the subset dᵢ, and the target residual self-interference level T_{SI}, and an updating unit for updating channel state information based on the computed phase responses ϕ_{d}. The control unit further comprises a decision unit for deciding based on the updated channel state information if any digitally controllable scatterer should be removed from the subset dᵢ and if so, updating the subset dᵢ to exclude that digitally controllable scatterer, and an information unit for informing other entities in the system about the subset dᵢ.

After identification of the subset dᵢ of DCSs based on the target residual SI level after propagation domain SI mitigation, the phase response ϕ_{d} of each DCS in the subset dᵢ is computed. By virtue of the subset dᵢ of the DCSs, the control unit is required to compute less measurement resulting in a reduced channel estimation overhead in contrast to conventional methods, where there is a large channel estimation overhead because of requirement of full CSI related to all DCSs. Moreover, the phase response ϕ_{d} of each DCS in the subset dᵢ, the transmitter and receiver beamformers and the transmitter powers are designed in such a way in order to meet the constraints on the target residual SI after propagation domain SI mitigation.

In a further implementation form, the control unit is further arranged to control the digitally controllable scatterers in the subset dᵢ.

In a further implementation form, the assessing unit is arranged to assess the level of the resulting residual self-interference based on the location of the digitally controllable scatterer and/or a characteristic of a beacon associated with the digitally controllable scatterer.

The beacon can be used in order to identify potential DCSs to be used for communication of the full duplex node.

In another aspect, the present disclosure provides an entity for use in a wireless communication network, said entity being a full duplex node, a base station, an access point or a digitally controllable scatterer, said entity comprising the control unit.

The entity comprising the control unit achieves all the advantages and technical effects of the control unit of the present disclosure. The entity is used as one of the full duplex node, or the base station or the access point.

In yet another aspect, the present disclosure provides a method for use in a wireless communications network including a full duplex node including a transmitter unit and a receiver unit, in a system comprising a set of one or more digital controllable scatterers, the transmitter unit and the receiver unit being coupled in such a way that a transmitted signal generates a residual self-interference at the receiver unit. The method comprises an assessment stage including the steps of identifying an initial set of potential digitally controllable scatterers to be used in the communication, for one or more digitally controllable scatterers in the initial set, assessing a resulting residual self-interference level at the full duplex node for one or more potential configurations of the digitally controllable scatterers, each potential configuration including one or more digitally controllable scatterers, or being an empty set, identifying a subset dᵢ of the initial set of digitally controllable scatterers to be associated with the full duplex node i, based on the assessments of residual self-interference levels for the one or more potential configurations, and providing information required for configuring the digitally controllable scatterers in the subset dᵢ.

The method achieves all the advantages and technical effects of the control unit of the present disclosure.

It is to be appreciated that all the aforementioned implementation forms can be combined.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person in the art that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a diagram of a full duplex (FD) node whose transmitted signal impinges on one or more digitally controllable scatterers (DCSs) and whose received signal includes signal incoming from one or more DCSs, in accordance with an embodiment of the present disclosure;

FIG. 2 is a block diagram that illustrates various exemplary components of a control unit, in accordance with an embodiment of the present disclosure;

FIG. 3 illustrates use of a DCS in order to reduce coupling between a transmitter (TX) unit and a receiver (RX) unit of a FD node, in accordance with an embodiment of the present disclosure;

FIGS. 4A-4E collectively illustrates different deployment scenarios of either one or more DCSs and a FD node in different communication architectures, in accordance with different embodiments of the present disclosure;

FIG. 5 is an operational flow diagram that illustrates signaling between a FD node, one or more DCSs, and one or more user equipments (UEs), in accordance with an embodiment of the present disclosure;

FIGS. 6A-6C collectively illustrates different deployment scenarios of one or more DCSs and one or more FD nodes in different communication architectures, in accordance with different embodiments of the present disclosure;

FIG. 7 is an operational flow diagram that illustrates signaling between one or more FD nodes, one or more DCSs, and an external entity, in accordance with an embodiment of the present disclosure;

FIG. 8 is an operational flow diagram that illustrates signaling between one or more FD nodes, one or more DCSs, without using an external entity, in accordance with an embodiment of the present disclosure;

FIGS. 9A-9E collectively illustrates different deployment scenarios of one or more DCSs and a FD node in different communication architectures, in accordance with different embodiments of the present disclosure;

FIG. 10 is an operational flow diagram that illustrates signaling between a FD node, one or more DCSs, and a base station, in accordance with an embodiment of the present disclosure;

FIG. 11 is an operational flow diagram that illustrates signaling between a FD node, one or more DCSs, and a base station, in accordance with another embodiment of the present disclosure;

FIG. 12 is an operational flow diagram that illustrates signaling between a FD node, one or more DCSs, and a base station, in accordance with yet another embodiment of the present disclosure; and

FIG. 13 is a flowchart of a method for use in a wireless communication network, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

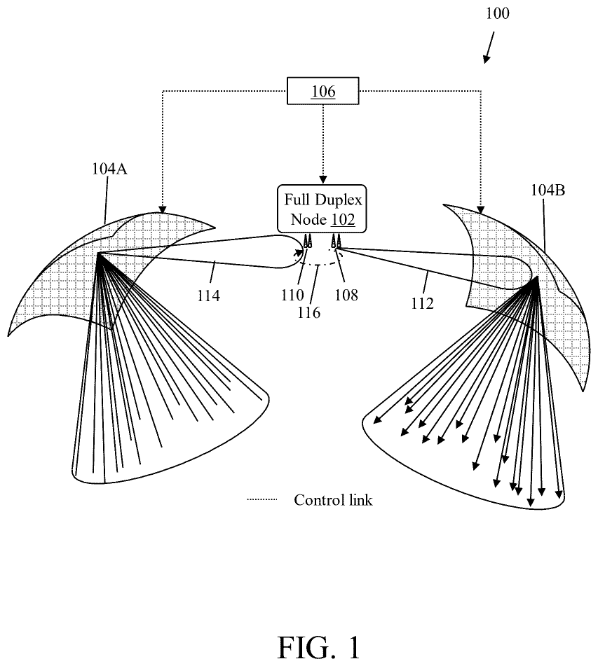

FIG. 1 is a diagram of a full duplex (FD) node whose transmitted signal impinges on one or more digitally controllable scatterers (DCSs) and whose received signal includes signal incoming from one or more DCSs, in accordance with an embodiment of the present disclosure. With reference to FIG. 1, there is shown a diagram 100 that depicts a full duplex (FD) node 102 and one or more DCSs, such as a first DCS 104A and a second DCS 104B. There is further shown a control unit 106, a transmitter (TX) unit 108 and a receiver (RX) unit 110. The FD node 102 includes the TX unit 108 and the RX unit 110. The control unit 106 is configured to control each of the first DCS 104A and the second DCS 104B and the FD node 102. There is further shown a transmitter beam 112 generated by a transmitter beamformer at the TX unit 108 of the FD node 102, a receiver beam 114 generated by a receiver beamformer at the RX unit 110 of the FD node 102 and a self-interference (SI) signal 116.

The FD node 102 may include suitable logic, circuitry, and/or interfaces that is configured to receive a signal from a transmitter (e.g., a base station or a user equipment) by use of the receiver unit 110 as well as transmit to a receiver (e.g., a base station or a user equipment) by use of the transmitter unit 108. Conventionally, there is a coupling between a transmitter unit and a receiver unit of a conventional FD node due to which a high-powered self-interference (SI) signal is generated which degrades the signal reception at the conventional FD node. By virtue of use of the first DCS 104A and the second DCS 104B, the effect of the high-powered SI signal is reduced at the FD node 102.

Each of the first DCS 104A and the second DCS 104B may include suitable logic, circuitry, and/or interfaces that is configured to provide a number of propagation paths between the FD node 102 and other communicating nodes, for example, a TX and a RX, in such a way that the effect of the self-interference signal 116 at the FD node 102 is reduced. Furthermore, each of the first DCS 104A and the second DCS 104B is configured to enlarge a region of coverage of the FD node 102. Each of the first DCS 104A and the second DCS 104B can be implemented either in form of an Intelligent Reflective Surface (IRS), or a Reflective Intelligent Surface (RIS) or a Large Intelligent Surface (LIS), where a large number of reflective elements or scattering elements, also known as unit elements, are used on a surface. Each of the first DCS 104A and the second DCS 104B is composed of many (e.g., thousands) of scattering elements and each scattering element has an adjustable phase shift. The phase shift vector ϕ_{d} for DCS d has a number of entries in the vector (i.e., size of the vector) ϕ_{d} that is equal to the number of scattering elements of DCS d. Each entry in the vector ϕ_{d} specifies a phase shift for a corresponding scattering element of DCS d.

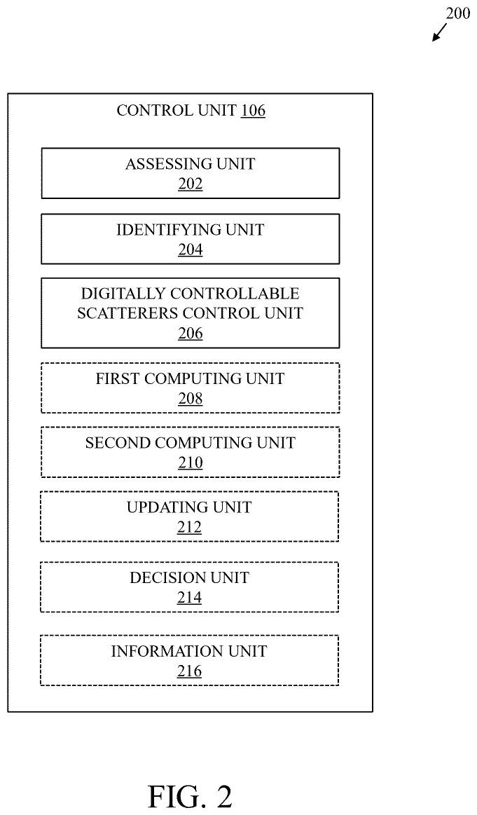

Each of the first DCS 104A and the second DCS 104B is configured as virtual extensions of the receiver unit 110 and the transmitter unit 108 of the FD node 102, respectively, and used for beamformer design of the FD node 102. For example, the FD node 102 is configured to transmit a signal by use of the transmitter beam 112 towards the second DCS 104B. The transmitter beam 112 includes focused energy transmitted by the transmitter unit 108 of the FD node 102. Similarly, the FD node 102 is configured to receive a signal by use of the receiver beam 114 from the first DCS 104A. Alternatively, the first DCS 104A may also be used to scatter towards the receiver unit 110 of the FD node 102 by using DCS beam focusing towards the receiver unit 110. Moreover, each of the first DCS 104A and the second DCS 104B is used to program a channel around the FD node 102 so that the incoming signal-of-interest (SoI) at the FD node 102 and an outgoing transmitted signal from the FD node 102 have a low acceptable overlap. This approach is used to reduce the residual SI level observed at the receiver unit 110 of the FD node 102 by exploiting the use of the first DCS 104A and the second DCS 104B for channel programming, specifically, self-interference channel programming. This approach is described in detail, for example, in FIG. 2.

FIG. 2 is a block diagram that illustrates various exemplary components of a control unit, in accordance with an embodiment of the present disclosure. FIG. 2 is described in conjunction with elements from FIG. 1. With reference to FIG. 2, there is shown a block diagram 200 of the control unit 106. The control unit 106 includes an assessing unit 202, an identifying unit 204, and a DCS control unit 206. The control unit 106 optionally includes a first computing unit 208, a second computing unit 210, an updating unit 212, a decision unit 214, and an information unit 216.

The control unit 106 is configured for use in a wireless communication network, for example, the wireless communication network may include at least one full duplex node (e.g., the FD node 102) one or more digitally controllable scatterers (e.g., the first DCS 104A and the second DCS 104B), a transmitter and a receiver. The full duplex node 102 includes a transmitter unit (e.g., the transmitter unit 108) and a receiver unit (e.g., the receiver unit 110), the transmitter unit 108 and the receiver unit 110 are coupled in such a way that a transmitted signal will generate a residual self-interference at the receiver unit 110.

The control unit 106 comprises the assessing unit 202 for identifying an initial set of potential digitally controllable scatterers to be used in the communication, and for one or more digitally controllable scatterers in the initial set, assessing a level of the resulting residual self-interference for one or more potential configurations of the digitally controllable scatterer, each potential configuration including one or more digitally controllable scatterers, or being an empty set. Initially, the assessing unit 202 of the control unit 106 is configured to identify the initial set of potential digitally controllable scatterers (DCSs) that support signal transmission of the FD node 102. The initial set also includes potential DCSs that support signal reception of the FD node 102. The identification of the initial set of potential DCSs for communication of the FD node 102 may also be referred to as a discovery of potential DCSs. For the one or more DCSs identified in the initial set, the assessing unit 202 is further configured to consider the one or more potential configurations of the DCSs (e.g., choice of DCSs and optionally phase response) for transmission support as well as reception support of the FD node 102. For each potential configuration of the DCSs, the assessing unit 202 is configured to assess the resulting residual self-interference (SI) level after propagation domain mitigation is performed. For example, an amount of overlap between transmission and reception directions associated with a DCS configuration can be used to assess the residual SI power level P_{SI} after propagation domain mitigation. In an implementation, the DCSs have fixed locations and the FD node 102 knows its own location. The FD node 102 may use this information to know the direction towards a given DCS. In such implementation, the signal assessment can be done using typical TX powers or a range of TX powers and typical TX and RX beams and related beamformers previously used or a set of predefined beamformers. Additionally, and optionally, for each configuration, two Signal-of-Interest (SoI) levels can be optionally assessed. One is an incoming SoI level received at the FD node 102 from a remote transmitter. The other one is the SoI level received from the FD node 102 at the FD node's intended receiver. Each SoI level assessment can be in form of a link power budget assessment. Moreover, the identified initial set may not have any DCS or is an empty set.

In accordance with an embodiment, the assessing unit 202 is arranged to assess the level of the resulting residual self-interference based on the location of the digitally controllable scatterer and/or a characteristic of a beacon associated with the digitally controllable scatterer. In an implementation, the assessing unit 202 is configured to assess the level of the resulting residual self-interference based on the location information related to the location of the DCSs identified in the initial set. For example, a DCS with a distance from the FD node 102 or other node that is greater than a specified value, is not identified in the initial set. In another implementation, the assessing unit 202 is configured to assess the level of the resulting residual self-interference based on the characteristic of the beacon associated with the DCS. The beacon can be sent by the DCS through active elements at the DCS or can be generated using modification of the DCS reflected or scattered signal, for example, via DCS modulation or any tool allowing the DCS to send a controllable signal. The beacon can be used to identify potential DCSs to use for communication with the FD node 102. This can be done, for example, by considering only DCSs from which beacon strength is above a certain value.

The control unit 106 further comprises the identifying unit 204 for identifying a subset dᵢ of the initial set of digitally controllable scatterers to be associated with the full duplex node 102 labeled also as full duplex node i, based on the assessments of residual self-interference levels for the one or more potential configurations. After assessing the resulting residual SI level and optionally the SoI level for the one or more DCSs identified in the initial set, the identifying unit 204 is configured to identify the subset dᵢ of the initial set of DCSs, which can be associated for communication of the FD node 102. The identifying unit 204 is configured to identify the subset dᵢ of the initial set of DCSs by taking into account a target residual SI power level T_{SI} after propagation domain mitigation.

In an implementation of the identifying unit 204, the subset dᵢ of DCSs can be obtained by choosing a set of DCSs that result in a residual SI power P_{SI} after propagation domain mitigation that meets the target residual T_{SI} according to Equation (1)

$${d}_{i} = \{ d ∈ \{ 1 , … , D \} \vert {P}_{SI} ( d ) \leq {T}_{SI} \} \qquad ( 1 )$$

In another implementation, the subset dᵢ of DCSs can be obtained by using the information about the SI level and also the SoI level. For example, a signal-to-interference-plus-noise ratio (SINR) may be considered as part of an optimization problem, where the SINR is given by P_{SoI}/P_{SI}, where P_{SoI} is the power of the signal of interest incoming at the FD node 102. The control unit 106 further comprises the digitally controllable scatterers control unit 206 for providing information required for configuring the digitally controllable scatterers in the subset dᵢ.

Optionally, the control unit 106 further comprises the first computing unit 208 for computing phase shifts ϕ_{d} for each digitally controllable scatterer d, in the subset dᵢ, taking into account a constraint defined for a target residual self-interference level at the receiver unit 110. The phase shifts ϕ_{d} for each DCS d, in the subset dᵢ are computed. If specific phase shifts vector is used by the identifying unit 204 or the DCS control unit 206, then that phase shift vector can be refined by the first computing unit 208 or can be kept same for simplicity. The computation of the phase shifts ϕ_{d} takes into account the constraint defined for the target residual SI level after propagation domain mitigation at the receiver unit 110. The first computing unit 208 may also consider the target SoI levels for computation of the phase shifts ϕ_{d}. Moreover, the first computing unit 208 may use any known algorithm for the computation of the phase shifts ϕ_{d} for each DCS d, in the subset dᵢ and feasibility of this solution can be checked by verifying that the residual SI level meets the target constraint T_{SI}. The first computing unit 208 computes the phase shifts ϕ_{d} for each DCS d, in the subset dᵢ instead of all DCSs identified in the initial set used conventionally, which significantly reduces the required computations.

Optionally, the control unit 106 further comprises the second computing unit 210 for computing transmitter and receiver beams at the full duplex node 102 taking into account the computed phase response of each digitally controllable scatterer in the subset dᵢ, and the target residual self-interference level T_{SI}. The transmitter (TX) and receiver (RX) beamformers and their resulting beams or related patterns can be obtained either by using a conventional technique with a beamformer on top of an antenna array or with other pattern controlling techniques like electronically steerable parasitic array radiator (ESPAR). The computation of the TX beam also includes computation of transmission power of the FD node 102, or allowed TX power range, or optimization of low noise amplifier (LNA) gain and sensitivity with TX power optimization, such that the constraint on the target residual SI level T_{SI} after propagation domain mitigation is met. The second computing unit 210 may also consider the target SoI levels for design of the TX and RX beams. Moreover, the second computing unit 210 may also be configured to use any conventional algorithm for beamforming design. The feasibility of using the conventional algorithm may be verified by checking that the residual SI level meets the target constraint T_{SI}. The second computing unit 210 is configured to optimize the TX and RX beams only based on each DCS d, in the subset dᵢ instead of all DCSs identified in the initial set used conventionally, which significantly reduces the complexity of the optimization algorithm.

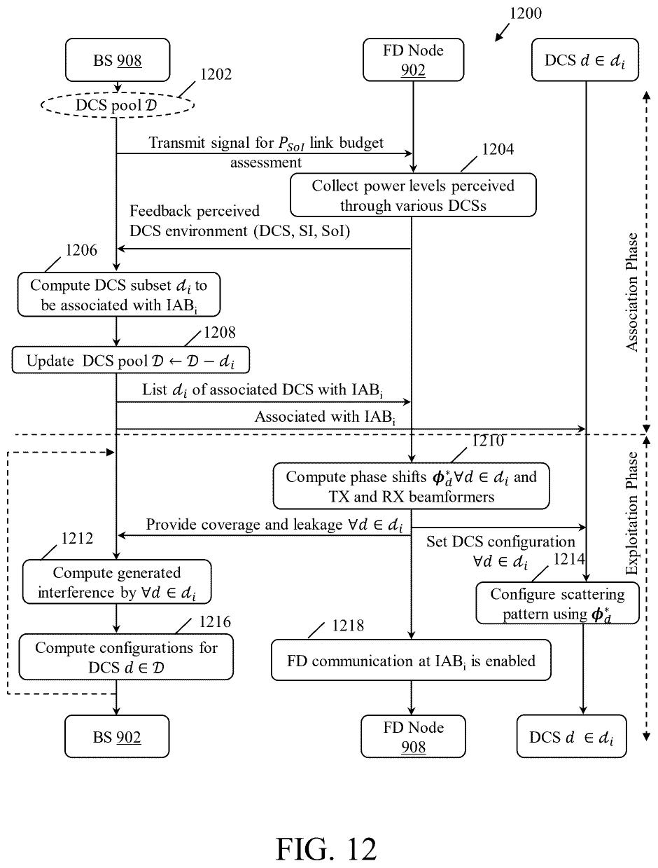

The computations of the phase shifts ϕ_{d} for each DCS d, in the subset dᵢ and the TX and RX beams can also be done in one step in a joint design and also include SoI levels, examples of such computations are described in detail, for example, in FIG. 12.

Optionally, the control unit 106 further comprises the updating unit 212 for updating channel state information based on the computed phase shifts ϕ_{d}. The computed phase shifts ϕ_{d} results in a new propagation channel (i.e., the propagation channel via a DCS is modified if the DCS's phase shifts are modified) hence, the channel state information (CSI) is updated accordingly. The updating unit 212 may use either measurements or exploit previously known channel information (e.g., a channel between the FD node 102 and DCS and a channel between DCS and other communication nodes) and DCS phases in order to recompute the updated channel state information related to the new DCS configuration.

Optionally, the control unit 106 further comprises the decision unit 214 for deciding based on the updated channel state information if any digitally controllable scatterer should be removed from the subset dᵢ and if so, updating the subset dᵢ to exclude that digitally controllable scatterer. The decision unit 214 is configured to decide to remove any DCS from the subset dᵢ on the basis of the computed phase shifts ϕ_{d}, or resulting TX and RX beams, or updated channel state information, or SI level or SoI level. Thereafter, the decision unit 214 is configured to update the subset dᵢ after removing the DCS from the subset dᵢ.

Optionally, the control unit 106 further comprises the information unit 216 for informing other entities in the system about the subset dᵢ. The DCSs in the subset dᵢ are reserved for the FD node 102. The information unit 216 is configured to inform other entities in the system about other DCSs that are not in the subset dᵢ and are available for other communication. Optionally, the information unit 216 is configured to inform served nodes including base station (BS), user equipments (UEs) or control entity of a chosen subset dᵢ of DCS and the FD node 102 TX power for improved performance (i.e., resource coordination and allocation).

In accordance with an embodiment, the control unit 106 is further arranged to control the digitally controllable scatterers in the subset dᵢ. The assessing unit 202, the identifying unit 204 and the DCSs control unit 206 may require signaling exchanges which is controlled by the control unit 106.

Additionally, the control unit 106 is configured to execute a pseudocode represented by an Algorithm 1. Algorithm 1 includes an association stage and an exploitation stage for each FD communicating node i (e.g., the FD node 102).

The assessing unit 202, identifying unit 204 and the DCS control unit 206 of the control unit 106 are configured to execute the association stage of Algorithm 1. For example, the assessing unit 202 is configured to assess the residual self-interference (SI) level to each DCS in an initial set after propagation domain mitigation is performed. The identifying unit 204 is configured to assess the residual SI level and optionally the SoI level to the one or more DCSs identified in the initial set and identify a subset dᵢ of the initial set of DCSs, which can be associated for communication of the FD node 102. The DCS control unit 206 is configured to provide information required for configuring the DCS in the subset dᵢ. Similarly, the first computing unit 208, the second computing unit 210, the updating unit 212, the decision unit 214 and the information unit 216 are configured to execute the exploitation stage of Algorithm 1. For example, the first computing unit 208 is configured to compute the phase shifts ϕ_{d} for each DCS d, in the subset dᵢ. The second computing unit 210 is configured to compute the TX and RX beams at the FD node 102 by considering the computed phase shifts ϕ_{d} of each DCS in the subset dᵢ, and the target residual self-interference level T_{SI}. The updating unit 212 is configured to update the channel state information (CSI) based on the computed phase shifts ϕ_{d} of each DCS in the subset dᵢ. The decision unit 214 is configured to decide if any DCS should be removed from the subset dᵢ based on the updated channel state information and if so, updating the subset dᵢ to exclude that DCS. The information unit 216 is configured to inform other entities in the system about the updated subset dᵢ.

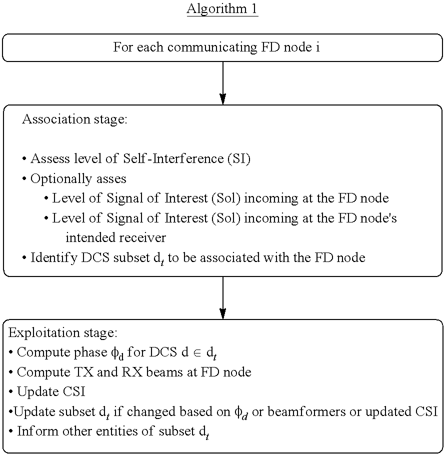

Moreover, Algorithm 1 results in a DCS choice and configuration and the TX and RX beams of the FD node 102 that are designed for reducing the SI in order to meet the residual SI constraints. Moreover, Algorithm 1 may also give an output of no DCS solution, where the subset dᵢ is an empty set. Also, Algorithm 1 can give as an output a solution where the receiver of the FD node 102 does not require DCS support hence, the FD node 102 uses DCSs in the subset dᵢ only for signal transmission. Vice versa, Algorithm 1 can give as an output a solution where the transmitter of the FD node 102 does not require DCS support hence, the FD node 102 uses DCSs in the subset dᵢ only for signal reception.

Thus, the control unit 106 significantly reduces the self-interference while improving the coverage area of the FD node 102. In contrast to conventional ways of FD communications assisted by DCS, the use of the control unit 106 reduces the channel estimation overhead and simplifies the optimization by exploiting the effect of DCS choice and programming on the residual SI. The identifying unit 204 of the control unit 106 is configured to narrow down the set of DCSs for use by using only partial CSI measurement and exchanges. The identifying unit 204 may also decide to use no DCS for communications of the FD node 102. By associating each DCS to a partial CSI related to the residual SI level after propagation domain mitigation and optionally SoI level, the identifying unit 204 is configured to narrow down the DCSs to be used by applying constraints on the target residual SI after propagation domain SI mitigation at the FD node 102 or constraints on SINR computed as P_{SoI}/P_{SI} ratio. After identification of the subset dᵢ of DCSs based on the target residual SI level after propagation domain SI mitigation, the phase shifts ϕ_{d} of each DCS in the subset dᵢ is computed. By virtue of the subset dᵢ of the DCSs, the control unit 106 has to compute less measurements resulting in a reduced channel estimation overhead in contrast to conventional methods, where there is a large channel estimation overhead because of requirement of full CSI related to all DCSs. Additionally, the control unit 106 is configured to take into account the target residual SI after propagation domain SI mitigation. This ensures that a pre-analog cancellation (or pre-ADC if no analog cancellation) SI level is not greater than a maximum allowed value. Moreover, the control unit 106 reduces the SI via the appropriate choice of the DCS that results in a reduced TX and RX coupling at the FD node 102 which further significantly improves the signal reception at the FD node 102.

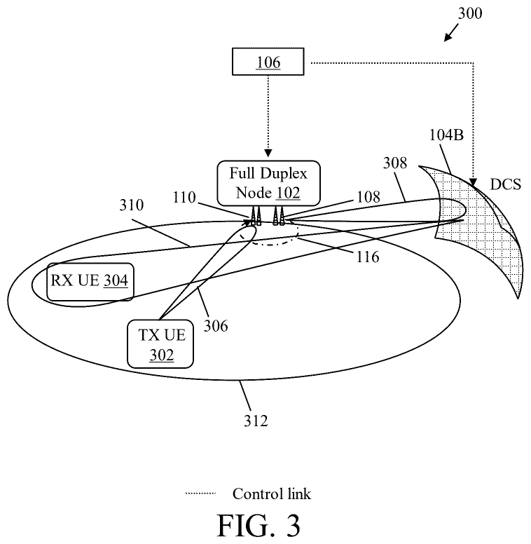

FIG. 3 illustrates use of a DCS in order to reduce coupling between a transmitter (TX) unit and a receiver (RX) unit of a FD node, in accordance with an embodiment of the present disclosure. FIG. 3 is described in conjunction with elements from FIGS. 1 and 2. With reference to FIG. 3, there is shown a communication system 300 that includes the FD node 102, the control unit 106, a DCS (e.g., the second DCS 104B), a TX UE 302 and a RX UE 304. The FD node 102 includes the RX unit 110 and the TX unit 108. There is further shown a first beam 306, a second beam 308, a third beam 310 and a coverage region 312.

The TX UE 302 may include suitable logic, circuitry, and/or interfaces that are configured to transmit a signal towards the receiver unit 110 of the FD node 102. Examples of the TX UE 302 may include, but are not limited to, a base station, an Internet-of-Things (IoT) device, a smart phone, a machine type communication (MTC) device, a computing device, an evolved universal mobile telecommunications system (UMTS) terrestrial radio access (E-UTRAN) NR-dual connectivity (EN-DC) device, a server, an IoT controller, a drone, a customized hardware for wireless telecommunication, a transmitter, or any other portable or non-portable electronic device.

The RX UE 304 may include suitable logic, circuitry, and/or interfaces that is configured to receive a signal from the transmitter unit 108 of the FD node 102. Examples of the RX UE 304 may include, but are not limited to, an Internet-of-Things (IoT) controller, a server, a smart phone, a customized hardware for wireless telecommunication, a receiver, or any other portable or non-portable electronic device.

In the communication system 300, the receiver unit 110 of the FD node 102 is configured to receive the first beam 306 from the TX UE 302. The first beam 306 represents a signal-of-interest (SoI) transmitted by the TX UE 302. Thereafter, the transmitter unit 108 of the FD node 102 is configured to transmit the second beam 308 to the second DCS 104B. The second DCS 104B is used to serve the RX UE 304 therefore, the second DCS 104B transmits the third beam 310 representing the SoI to the RX UE 304. The second beam 308 leaving the transmitter unit 108 of the FD node 102 does not overlap with the direction of the first beam 306 coming from the TX UE 302. The second DCS 104B is used to steer the second beam 308 transmitted by the transmitter unit 108 of the FD node 102 away from the receiver unit 110 of the FD node 102 while at the same time serving the RX UE 304. Thus, the FD node 102 successfully employs the second DCS 104B to achieve propagation domain SI mitigation and to reach the intended receiver (i.e., the RX UE 304). In this way, the second DCS 104B may be used as a tool for propagation domain SI mitigation with the advantage of using all resources (e.g., TX and RX beamformers) in order to transmit the signals of interest to the intended receiver (i.e., the RX UE 304) of the FD node 102. Moreover, the coverage region 312 represents a feasible coverage region for the RX UE 304 to receive the signal-of-interest from the second DCS 104B.

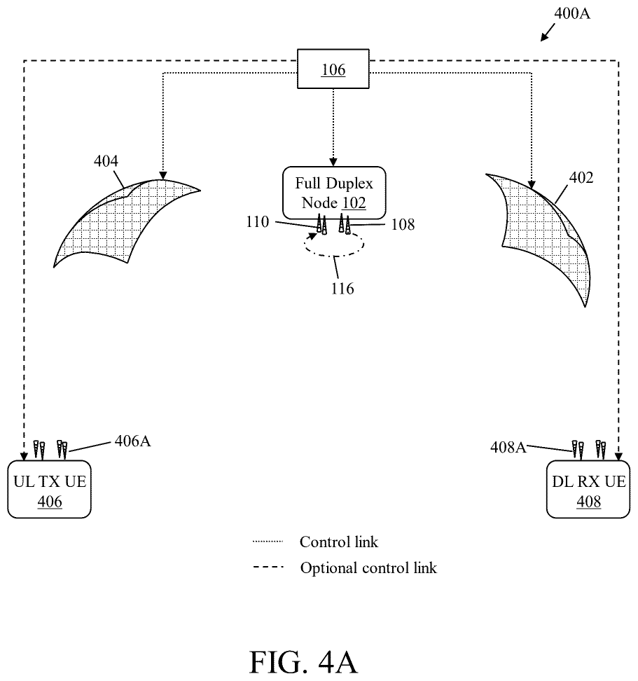

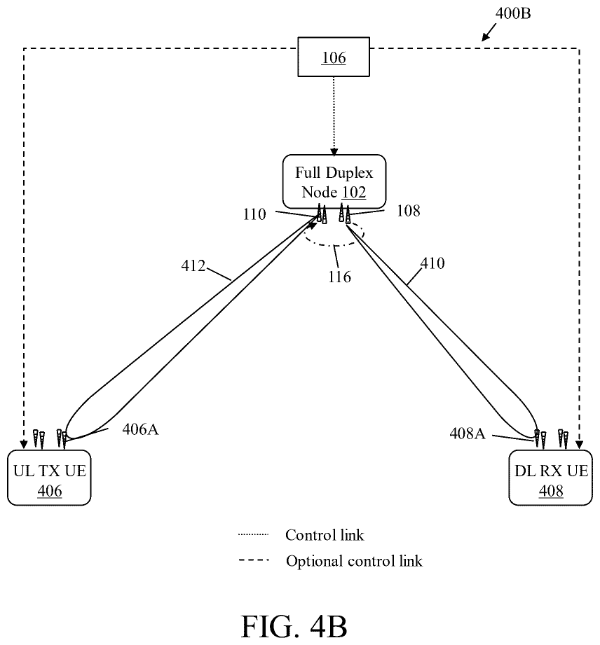

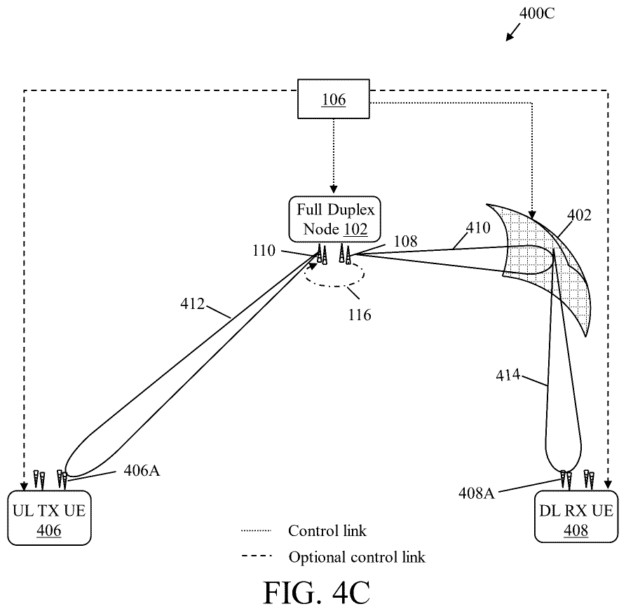

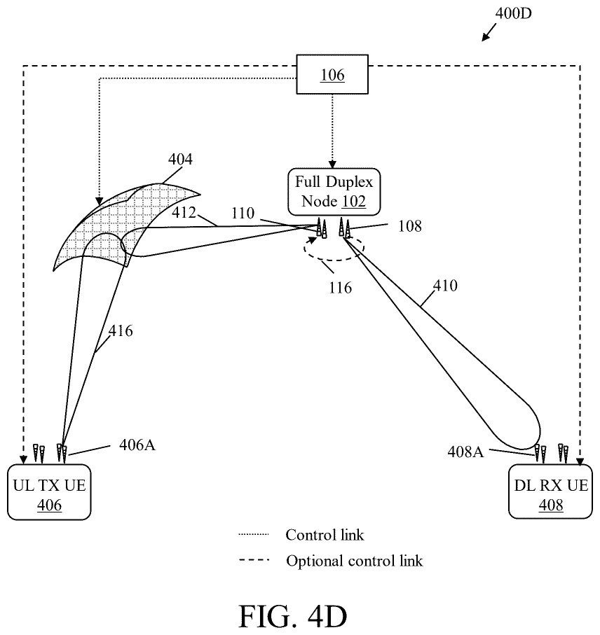

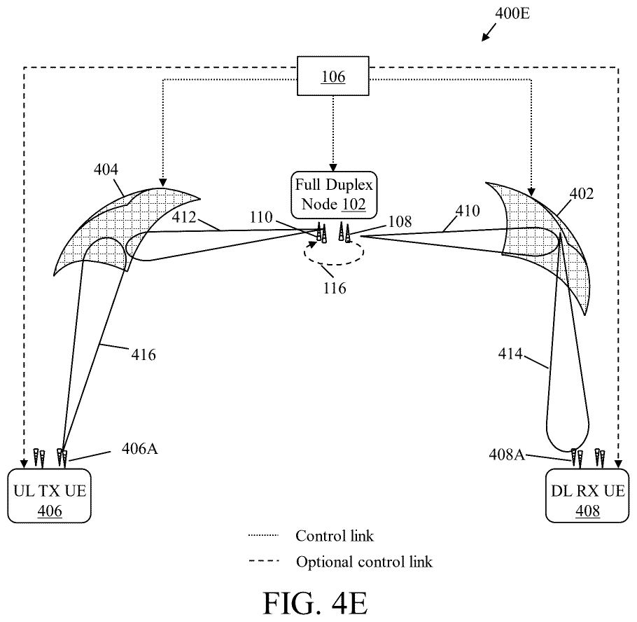

FIGS. 4A-4E collectively illustrate different deployment scenarios of either one or more DCSs and a FD node in different communication systems, in accordance with different embodiments of the present disclosure. FIGS. 4A-4E are described in conjunction with elements of FIGS. 1, 2, and 3. With reference to FIG. 4A, there is shown a communication system 400A that includes the FD node 102 (of FIG. 1), a first DCS 402, a second DCS 404, an uplink (UL) TX UE 406 and a downlink (DL) RX UE 408. There is further shown a transmitter unit 406A associated with the UL TX UE 406 and a receiver unit 408A associated with the DL RX UE 408. The control unit 106 optionally exchanges information with the UL TX UE 406 and the DL RX UE 408.

An entity for use in a wireless communication network, said entity being a full duplex node, a base station, an access point or a digitally controllable scatterer, said entity comprising a control unit (e.g., the control unit 106). In the communication system 400A, the FD node 102 can be configured to act as the base station (BS) or the access point (AP).

Each of the first DCS 402 and the second DCS 404 correspond to the second DCS 104B and the first DCS 104A (of FIG. 1), respectively. Each of the first DCS 402 and the second DCS 404 can be configured for communication with the FD node 102. In order to use the first DCS 402 and the second DCS 404 in different deployment scenarios, the control unit 106 is configured to execute Algorithm 1. The following inputs are considered for execution of Algorithm 1: an estimation of a non-DCS channel from the UL TX UE 406 to the receiver unit 110 of the FD node 102 (may also be referred to as an UL non-DCS channel), an estimation of a non-DCS channel from the transmitter unit 108 of the FD node 102 to the DL RX UE 408 (may also be referred to as a DL non-DCS channel), an estimation of locations of the first DCS 402 and the second DCS 404, an estimation of location of the FD node 102, number of DCSs used, D=2 are used for different deployment scenarios, (described in detail, for example, in FIGS. 4C to 4E), an estimation of a residual SI power level after propagation domain SI mitigation P_{SI}, a constraint on the residual, for example, the residual must be less than or equal to the target T_{SI}. The different stages of Algorithm 1, such as the association stage and the exploitation stage are described in detail, for example, in FIGS. 4B to 4E.

Now referring to FIG. 4B, there is shown a communication system 400B that includes a TX beam 410 and a RX beam 412 at the FD node 102. In the communication system 400B, no DCS is used for communication with the FD node 102. The control unit 106 is configured to execute the association stage of Algorithm 1. In the association stage, the control unit 106 is configured to use the estimated UL non-DCS channel and DL non-DCS channel for assessing the resulting residual SI power level after propagation domain mitigation P_{SI} using the TX beam 410 and the RX beam 412 at the FD node 102 when no DCS is used. The residual SI power level P_{SI} is compared against the target residual T_{SI} and there are following two possible outcomes. A first outcome is obtained when the residual SI power level meets the required constraint (P_{SI}≤T_{SI}) then, the association stage gives as an output that DCS is not required for communication with the FD node 102 and the association stage ends providing the subset dᵢ of DCS as an empty set (dᵢ=θ). A second outcome is obtained when the residual SI power level does not meet the required constraint (P_{SI}>T_{SI}), which is the case for example if the DL RX UE 408 lies in problematic region and thus cannot be served directly by the FD node 102 due to large SI (e.g., the SI signal 116). If this second outcome is obtained, then the control unit 106 is configured to consider, as part of the association stage of Algorithm 1, the use of DCS as described in detail, for example, in FIG. 4C. The first outcome of the association stage of Algorithm 1 with the subset dᵢ of DCSs for full duplex node i as an empty set (dᵢ=θ) is illustrated in the communication system 400B. As shown in FIG. 4B, no DCS is used for communication with the FD node 102. Instead of DCS, the TX beam 410 and the RX beam 412 are used for communication through the FD node 102. The TX beam 410 is used for transmission from the FD node 102 to the DL RX UE 408. The RX beam 412 is used for reception at the FD node 102 from the UL TX UE 406.

Now referring to FIG. 4C, there is shown a communication system 400C that includes the FD node 102, the first DCS 402, the UL TX UE 406, the DL RX UE 408, the TX beam 410 and the RX beam 412. There is further shown a DCS scattered beam 414.

In the scenario shown in FIG. 4C, the control unit 106 is configured to continue with the association stage of Algorithm 1 and as part of this association stage consider the use of the first DCS 402 in order to assist the transmission from the FD node 102. The first DCS 402 can be selected for this instance of the association state in one of three ways. The three ways include either the first DCS 402 can be selected either randomly or when the first DCS 402 is located in a direction from the FD node 102 that does not overlap with the direction of the UL TX UE 406 (i.e., the direction can be known from the UL non-DCS channel) or when the DL RX UE 408 is in a sector for which the first DCS 402 provides coverage, this sector can be estimated, for example, from the DL non-DCS channel and location of the first DCS 402. After selection of the first DCS 402, the control unit 106 is configured to assess the resulting residual SI power level after propagation domain mitigation when using the TX beam 410 at the FD node 102 towards the first DCS 402 and the RX beam 412 to receive a signal-of-interest from the UL TX UE 406. The first DCS 402 is configured to scatter the signal-of-interest to the DL RX UE 408 by use of the DCS scattered beam 414. The assessment of the resulting residual SI power level can be done using the knowledge of the UL non-DCS channel and the location of the first DCS 402 or, if available, previous channel estimates for channel between the FD node 102 and the first DCS 402 can also be used. The obtained residual SI power level after propagation domain mitigation with the use of the first DCS 402 is compared against the target constraint and there are the following two possible outcomes. A first outcome is obtained when the residual SI power level meets the required constraint (P_{SI}≤T_{SI}) then, the association stage gives as an output that the first DCS 402 is required for transmission with the FD node 102 and the association stage ends providing the subset dᵢ of DCS as dᵢ{the first DCS 402}. A second outcome is obtained when the residual SI power level does not meet the required constraint (P_{SI}>T_{SI}) and the control unit 106 is configured to consider, as part of the association stage of Algorithm 1, the DCS configuration described in detail, for example, in FIG. 4D. The first outcome of the association stage of Algorithm 1 with the subset dᵢ of DCS as dᵢ{the first DCS 402} is illustrated in the communication system 400C. As shown in FIG. 4C, the first DCS 402 along with the TX beam 410, the RX beam 412 and the DCS scattered beam 414 are used for communication of the FD node 102.

Now referring to FIG. 4D, there is shown a communication system 400D that includes the FD node 102, the second DCS 404, the UL TX UE 406, the DL RX UE 408, the TX beam 410 towards DL RX UE 408 and the RX beam 412. There is further shown a TX beam 416 transmitted by the UL TX UE 406.

In the scenario shown in FIG. 4D the control unit 106 is further configured to continue with the association stage of Algorithm 1 and as part of this association stage compute the resulting residual SI power level after propagation domain mitigation when using the RX beam 412 at the FD node 102 to receive from the second DCS 404 and the TX beam 410 at the FD node 102 to transmit the SoI to the DL RX UE 408. The second DCS 404 is configured to receive the SoI from the UL TX UE 406 by use of the TX beam 416 of UL TX UE 406. The assessment of the resulting residual SI power level can be done using the knowledge of the DL non-DCS channel and the location of the second DCS 404 or, if available, previous channel estimates for channel between the second DCS 404 and the FD node 102 can also be used. The obtained residual SI power level after propagation domain mitigation with the use of the second DCS 404 to change the direction of arrival of the SoI arriving at the FD node 102 is compared against the target constraint and there are the following two possible outcomes. A first outcome is obtained when the residual SI power level meets the required constraint (P_{SI}≤T_{SI}) then, the association stage gives as an output that the second DCS 404 is required for reception of the FD node 102 and the association stage ends providing the subset dᵢ of DCS as dᵢ={the second DCS 404}. A second outcome is obtained when the residual SI power level does not meet the required constraint (P_{SI}>T_{SI}) and the control unit 106 is configured to consider, as part of the association stage of Algorithm 1, the DCS as described in detail, for example, in FIG. 4E. The first outcome of the association stage of Algorithm 1 with the subset dᵢ of DCS as dᵢ{the second DCS 404} is illustrated in the communication system 400D. As shown in FIG. 4D, the second DCS 404 along with the TX beam 410, the RX beam 412 and the TX beam 416 of UL TX UE 406 are used for communication with the FD node 102.

Now referring to FIG. 4E, there is shown a communication system 400E that includes the FD node 102, the first DCS 402, the second DCS 404, the UL TX UE 406, the DL RX UE 408, the TX beam 410, the RX beam 412, the scattered beam 414 scattered by DCS 402 and the TX beam 416 transmitted by the UL TX UE 406.

For the scenario shown in FIG. 4D, the residual SI power level does not meet the required constraint (P_{SI}>T_{SI}) and therefore, the control unit 106 is configured to use the first DCS 402 and the second DCS 404 as in FIG. 4E. In the scenario shown in FIG. 4E the first DCS 402 is used to assist the transmission of the FD node 102 since the first DCS 402 is located in a direction from the FD node 102 that does not overlap with the direction of the UL TX UE 406. Furthermore, the second DCS 404 is used to assist the reception at the FD node 102 since the second DCS 404 is available and located in a direction from the FD node 102 that does not overlap with the direction of the DL RX UE 408. The control unit 106 is configured to continue with the association stage of Algorithm 1 and as part of this association stage computes the resulting residual SI power level after propagation domain mitigation when using the TX beam 410 at the FD node 102 towards the first DCS 402 and the RX beam 412 to receive the signal from the second DCS 404. The assessment of the resulting residual SI power level can be done using knowledge of locations of the first DCS 402 and the second DCS 404 or, if available, previous information on channel estimates such as RSSI, CSI, for channel between the FD node 102 and the first DCS 402 can also be used. The obtained residual SI power level after propagation domain mitigation with the use of the first DCS 402 and the second DCS 404 is compared against the target constraint and there are the following two possible outcomes. A first outcome is obtained when the residual SI power level meets the required constraint (P_{SI}≤T_{SI}) then, the association stage gives as an output that the first DCS 402 and the second DCS 404 are required for transmission and reception at the FD node 102 and the association stage ends providing the subset dᵢ of DCS as dᵢ={the first DCS 402 and the second DCS 404}. A second outcome is obtained when the residual SI power level does not meet the required constraint (P_{SI}>T_{SI}) then, the association stage of Algorithm 1 provides the assessment that the FD communication is unfeasible given the target residual SI power T_{SI}.

The outcome of the association stage of Algorithm 1 with the subset dᵢ of DCS as dᵢ={the first DCS 402 and the second DCS 404} is illustrated in the communication system 400E. As shown in FIG. 4E, the first DCS 402, and the second DCS 404 along with the TX beam 410, the RX beam 412, the DCS scattered beam 414 and the TX beam 416 transmitted by the UL TX UE 406 are used for communication with the FD node 102.

In an implementation, instead of assessing the residual SI power level, P_{SI} and the target residual SI power level, T_{SI}, the control unit 106 may be configured to execute the association stage of Algorithm 1 by taking into account the incoming SoI at the FD node 102 and the related SINR. In case of considering the incoming SoI at the FD node 102, the following steps are considered for execution of Algorithm 1: (i) Input to Algorithm 1 is a target SINR at the FD node 102, T_{SINR} which is a constraint on the SINR: the SINR must be greater than or equal to the target T_{SINR}. (ii) At each step, where the residual SI power level P_{SI} is assessed, the SINR at the FD node 102 is also assessed by computing P_{SoI}/P_{SI} where P_{SoI} is the received power of the incoming SoI (i.e., signal received from the UL TX UE 406) at the FD node 102. The P_{SoI} can be estimated based on the knowledge of the UL non-DCS channel and location of the first DCS 402 and the second DCS 404. The P_{SoI} can also be estimated via measurement of signal strength and this estimation has less overhead than CSI measurements. (iii) At each step, where the control unit 106 checks if the constraint on the residual SI is met (P_{SI}≤T_{SI}), the control unit 106 also checks if the target SINR is met ((P_{SoI}/P_{SI})≥T_{SINR}). When both constraints are met this means that the related subset of DCS, dᵢ is a valid subset.

In another implementation, instead of using the target residual SI power level T_{SI} and the target SINR T_{SINR} at the FD node 102, the control unit 106 may also be configured to use the target SoI power level for the SoI at the intended receiver (i.e., DL RX UE 408) of the FD node 102. This can be achieved via the following steps considered for execution of Algorithm 1: (i) input to Algorithm 1 is a target SoI power at the intended receiver (i.e., DL RX UE 408) of the FD node 102 T_{SoI,FDIR} which sets a constraint on P_{SoI,FDIR} which is the SoI power at the intended receiver (i.e., DL RX UE 408) of the FD node 102 where the SoI power P_{SoI,FDIR} must be greater than or equal to the target T_{SoI,FDIR}. (ii) At each step, where the SI power level P_{SI} and the SINR are assessed, the P_{SoI,FDIR} is also assessed. The P_{SoI,FDIR} can be estimated based on the knowledge of the DL non-DCS channel and location of the first DCS 402 and the second DCS 404. The P_{SoI,FDIR} can also be estimated via measurement of signal strength and this estimation has less overhead than CSI measurements. (iii) At each step, where the control unit 106 checks if the constraint on the residual is met (P_{SI}≤T_{SI}), the control unit 106 also checks if the constraint on the SINR is met ((P_{SoI}/P_{SI})≥T_{SINR}), the control unit 106 also checks if the constraint on SoI (P_{SoI,FDIR}≥T_{SoI,FDIR}) at the intended receiver (i.e., DL RX UE 408) of the FD node 102 is met. When the three constraints are met this means that the related subset of DCS, dᵢ is a valid subset.

The association stage just described provides an example embodiment of a possible order of assessing the different possible configurations. In this example the order of configurations to consider was configuration in FIG. 4B, then configuration in FIG. 4C, then FIG. 4D, followed by FIG. 4E. This order can be changed in other possible embodiments of the Algorithm 1, where for example assessment of configurations in FIG. 4C and FIG. 4D are reversed with respect to the order considered in the previous example embodiment, or are parallelized. The assessment for configuration in FIG. 4E can be considered as an extra step to the assessment in FIG. 4C or FIG. 4D or the parallelized version, as well as a first step without any of the previous assessments.

After execution of the association stage of Algorithm 1, which has been described in detail, for example, in FIGS. 4A-4E, the control unit 106 is configured to execute the exploitation stage of Algorithm 1. In order to execute the exploitation stage of Algorithm 1, the control unit 106 is configured to compute phase configuration ϕ_{d} for the scattering elements of each DCS d∈dᵢ. The control unit 106 is further configured to compute the TX beam 410 and the RX beam 412 at the FD node 102 while taking into account the target residual SI power level T_{SI}. In computation of the phase shifts and the TX-RX beams, any such values used in the association stage can be reutilized or refined here. Also, further channel measurements can be triggered in order to obtain new estimates of channels via the first DCS 402 and the second DCS 404 (e.g., overall channels the UL TX UE 406→the second DCS 404→the FD node 102 and from the FD node 102→the first DCS 402→the DL RX UE 408) and this can be used for computation of ϕ_{d} and the TX beam 410 and the RX beam 412 in order to minimize the residual SI power level after propagation domain SI mitigation or optionally to maximize SINR (P_{SoI}/P_{SI}) power ratio. It is to be noticed that any measurement computed can be restricted to the DCSs in the subset dᵢ therefore, the number of required measurements is already less than having to do measurements related to all DCSs which is done conventionally. The control unit 106 is configured to update CSI and/or the subset dᵢ and recompute channels with the latest ϕ_{d} or trigger new channel estimation. The control unit 106 is further configured to inform other entities of the DCS subset dᵢ.

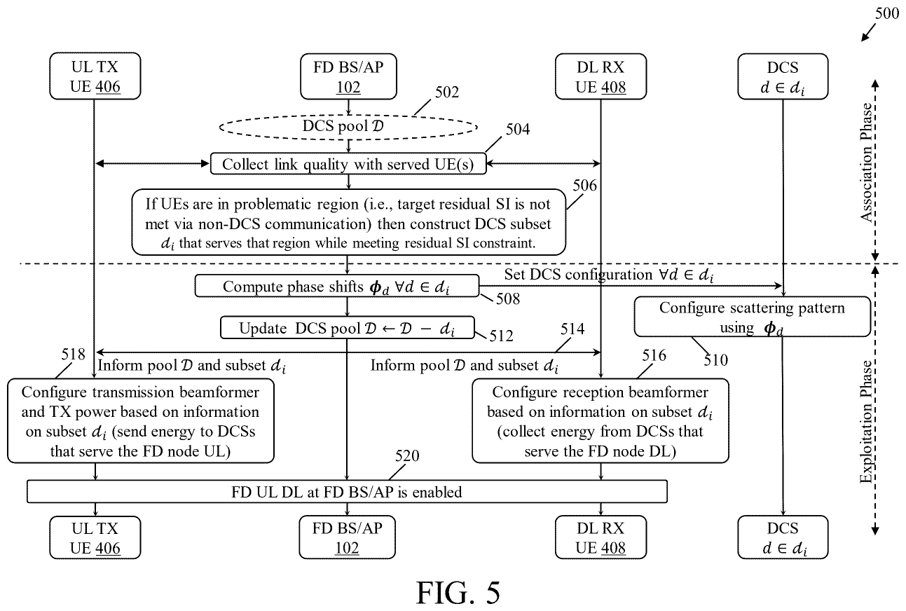

FIG. 5 is an operational flow diagram that illustrates signaling between a FD node, one or more DCSs, and one or more user equipments (UEs), in accordance with an embodiment of the present disclosure. FIG. 5 is described in conjunction with elements from FIGS. 1, 2, 3, and 4A-4E. With reference to FIG. 5, there is shown a flowchart 500 that includes operations 502 to 520 which are executed by the FD node 102, the UL TX UE 406, the DL RX UE 408 and one or more DCSs, such as the first DCS 402 and the second DCS 404.

At operation 502, the control unit 106 is configured to identify an initial set of potential DCSs to be used for communication with the FD node 102. The initial set is denoted as a DCS pool [symbol] .

At operation 504, the control unit 106 is configured to collect link quality from the served UEs, such as the UL TX UE 406 and the DL RX UE 408.

At operation 506, the control unit 106 is configured to identify if any UE lies in a problematic region and, if the target residual SI power level T_{SI} is not met via non-DCS communication, then, the control unit 106 is configured to construct DCS subset dᵢ, that is not an empty set, and composed of DCSs that serves the problematic region while fulfilling the residual SI constraint. The selection of the subset dᵢ of DCSs can be performed via knowledge of regions served by the DCSs (i.e., the first DCS 402 and the second DCS 404).

The operations 502, 504 and 506 correspond to the association stage of Algorithm 1. After execution of the association stage, the control unit 106 is configured to execute the exploitation stage of Algorithm 1.

At operation 508, the control unit 106 is configured to compute phase configuration of each of the scattering elements of each DCS in the subset dᵢ. The phase shifts ϕ_{d} define the radiation pattern or scattering pattern of the DCS d. After computing the phase shifts, the control unit 106 is configured to set configuration of each DCS in the subset dᵢ.

At operation 510, the control unit 106 is configured to set the scattering pattern of each DCS in the subset dᵢ.

At operation 512, the control unit 106 is configured to update the subset of DCS dᵢ.

At operation 514, the control unit 106 is configured to inform each of the UL TX UE 406 and the DL RX UE 408 about the updated subset of DCS dᵢ.

At operation 516, the DL RX UE 408 is configured to receive the SoI based on the subset dᵢ. For example, by use of the TX beam 410 through the first DCS 402 and the scattered beam 414, the first DCS 402 is configured to assist the transmission from the FD node 102.

At operation 518, the UL TX UE 406 is configured to transmit the SoI based on the subset dᵢ. For example, the UL TX UE 406 can transmit towards the second DCS 404 that is configured to assist the reception at the FD node 102.

At operation 520, the FD node 102, the UL TX UE 406 and the DL RX UE 408 and the DCSs in subset of DCS dᵢ are used for communication with an improved signal quality.

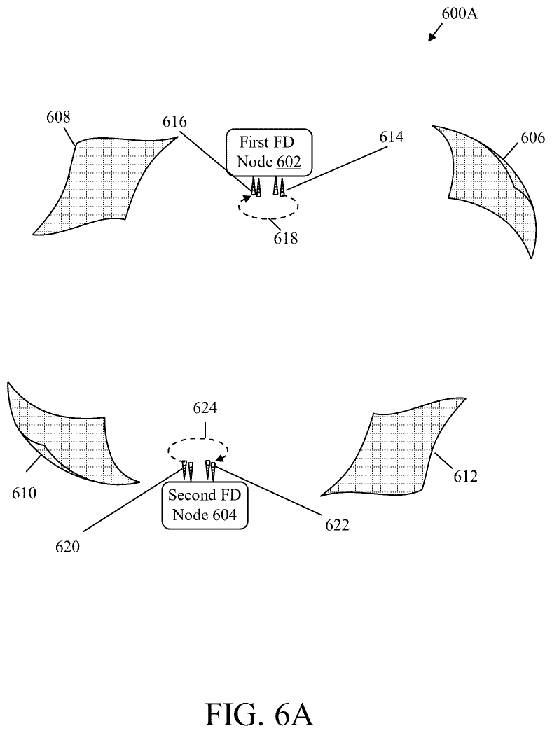

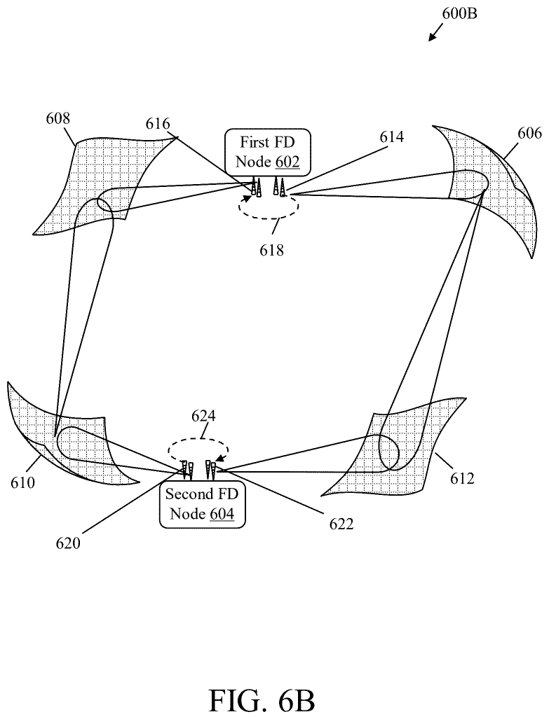

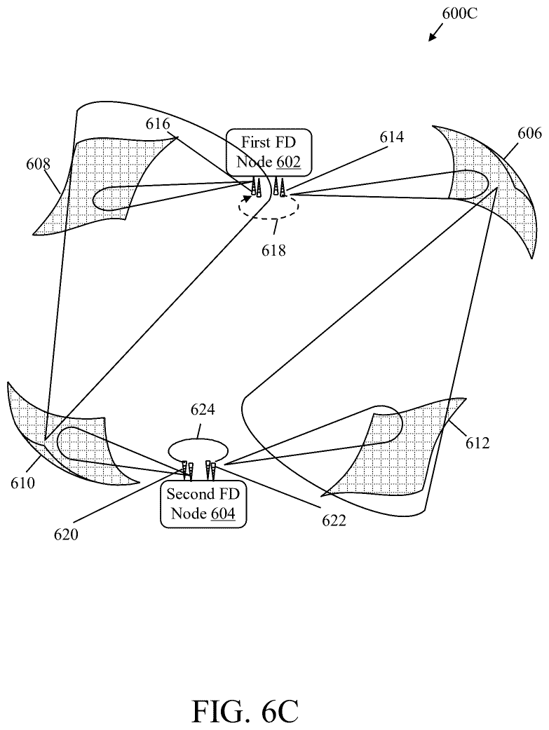

FIGS. 6A-6C collectively illustrates different deployment scenarios of one or more DCSs and one or more FD nodes in different communication systems, in accordance with different embodiments of the present disclosure. FIGS. 6A-6C are described in conjunction with elements of FIGS. 1, 2, 3, 4A-4E, and 5. With reference to FIG. 6A, there is shown a communication system 600A that includes a first FD node 602, a second FD node 604, a first DCS 606, a second DCS 608, a third DCS 610, and a fourth DCS 612. There is further shown a first TX unit 614, a first RX unit 616 and a first self-interference (SI) signal 618 associated with the first FD node 602. Similarly, there is shown a second TX unit 620, a second RX unit 622 and a second SI signal 624 associated with the second FD node 604.

Each of the first FD node 602 and the second FD node 604 has similar features as that of the FD node 102 (of FIG. 1). In FIG. 6A, each of the first FD node 602 and the second FD node 604 are required to communicate with each other in full-duplex mode. Each of the first FD node 602 and the second FD node 604 is configured to execute Algorithm 1. The following inputs are considered for execution of Algorithm 1: (i) an estimation of relative locations between each of the first DCS 606, the second DCS 608, the third DCS 610, and the fourth DCS 612 and each of the first FD node 602 and the second FD node 604. (ii) Total number of DCS (e.g., D=4). (iii) A target residual SI power level after propagation domain SI mitigation, T_{SI}. (iv) A constraint on the residual: the residual must be less than or equal to the target, T_{SI}.

Each of the first FD node 602 and the second FD node 604 is configured to execute the association stage of Algorithm 1. The steps of the association stage are described in the following way:

In an exemplary scenario, at each FD node i, i∈{1,2}:

(i) The δ DCSs closest to any FD node (e.g., the first FD node 602, the second FD node 604) are preselected. Given that there is a total of D DCSs then the value of δ has to be in the range 0≤δ≤D. As shown in FIG. 6A, there are in total 4 DCSs (D=4) then δ can be either 0, 1, 2, 3, or 4.

(ii) For the δ DCSs preselected, all the possible configurations of preselected DCSs for providing assistance in transmission and reception at each of the first FD node 602 and the second FD node 604 are considered. For each configuration of the preselected DCSs, each of the first FD node 602 and the second FD node 604 is configured to assess the residual SI power level after propagation domain mitigation based on the directions to (TX signal direction) and from (RX signal direction) the preselected DCSs. The closer the to and from directions are (i.e., the closer the TX and RX signal directions at a FD node) the larger SI level is. By associating the to and from directions with respectively, a TX beam and beamformer design and a RX beam and beamformer design then the assessment of the residual SI power level after propagation domain mitigation can be improved. In an implementation, an estimation of a channel between any of the first FD node 602 and the second FD node 604 and the δ preselected DCSs can be performed and use the estimation for the TX and RX beamformer design. For a configuration that corresponds to a case of not using any DCS then characteristics of the TX and RX units (e.g., the first TX unit 614 and the first RX unit 616 of the first FD node 602 and the second TX unit 620 and the second RX unit 622 of the second FD node 604) and proximity between the TX and RX units at the FD nodes are used for SI power level assessment.

(iii) After the SI power level assessment, a list dᵢ of DCS for transmission and reception enhancement of the FD node i (e.g., the first FD node 602) is defined based on the configuration that results on the lowest SI power level. The list and the related SI level is shared by the controllers with a central node (e.g., a base station) or exchanged with the controller of the other FD nodes' controller (e.g., the controller of the second FD node 604). Optionally, if levels of SoI are also available (for example, due to previous or triggered link budget measurements) then, the SoI level is also shared with controller central node (i.e., a base station) or exchanged between the controllers of the two FD nodes (i.e., the first FD node 602 and second FD node 604).

If the lists d₁ and d₂ and corresponding choices of DCSs for transmission and reception enhancement of the FD nodes provide a feasible configuration (e.g., a DCS used by the first FD node 602 is not used by the second FD node 604) then, Algorithm 1 proceeds with the exploitation stage, after having updated each of the first FD node 602 and the second FD node 604 with the list of DCSs that are reserved for the FD communication. If the configuration based on the lists d₁ and d₂ and corresponding choices of DCSs is not feasible then, Algorithm 1 returns to the association stage while excluding the unfeasible configuration. Examples of feasible configurations are shown in detail, for example, in FIGS. 6B and 6C.

It is to be understood by a person skilled in the art that all these metrics and assessment quantities are nothing but examples and do not limit the scope of the present disclosure.

Now referring to FIG. 6B, there is shown a communication system 600B that illustrates the use of the first DCS 606 and the second DCS 608 for the transmission and reception of the first FD node 602, respectively. And the third DCS 610 and the fourth DCS 612 is used to support the transmission and reception of the second FD node 604, respectively. Alternatively stated, the association of Algorithm 1 provides the outputs as d₁={the first DCS 606 and the second DCS 608} and d₂={the third DCS 610 and the fourth DCS 612}. In the communication system 600B, at each FD node, the DCS closest to the TX units (e.g., the first TX unit 614 and the second TX unit 620) is chosen for transmission enhancement and the DCS closest to the RX units (e.g., the first RX unit 616 and the second RX unit 622) is chosen for reception enhancement.

Now referring to FIG. 6C, there is shown a communication system 600C that illustrates the use of the first DCS 606 and the second DCS 608 for supporting the transmission and reception at the first FD node 602, respectively. And the third DCS 610 and the fourth DCS 612 is used to support the transmission and reception at the second FD node 604, respectively. Alternatively stated, the association of Algorithm 1 provides the outputs as d₁={the first DCS 606 and the second DCS 608} and d₂={the third DCS 610 and the fourth DCS 612}. In the communication system 600C, the first DCS 606 and the third DCS 610 are configured to scatter wide beams in order to provide large coverage area.

After execution of the association stage of Algorithm 1, each of the first FD node 602 and the second FD node 604 is configured to execute the exploitation stage of Algorithm 1. The steps of the exploitation stage are described in the following way:

(i) Each of the first FD node 602 and the second FD node 604 is configured to compute phase shift ϕ_{d} of DCS d∈d₁ and DCS d∈d₂. During computation of the phase shifts, it is to be noticed that if an entity or entities computing the phase shifts ϕ_{d} of DCSs have information of both d₁ and d₂, the information can be exploited to direct the signal to the first FD node 602 and the second FD node 604. As shown in FIG. 6B, the first FD node 602 is using the first DCS 606 for transmission enhancement and the second FD node 604 is using the fourth DCS 612 for reception enhancement then the phase shifts ϕ_{d} can be chosen in such a way that a scattered signal from the first DCS 606 is towards the fourth DCS 612. If the information of both d₁ and d₂ is not known to the entity computing the phase shifts ϕ_{d} as would be the case where the phase shifts ϕ_{d} of DCS d∈dᵢ are computed only at the first FD node 602 without knowing d₂ and the phases shifts ϕ_{d} of DCS d∈d₂ are computed only at the second FD node 604 without knowing dᵢ then, the DCSs can be set to scatter a wide beam or target a beam towards the other node, as shown in detail, for example, in FIG. 6C.

(ii) Each of the first FD node 602 and the second FD node 604 is configured to compute TX and RX beams while taking into account the target residual SI power level T_{SI}.

In computation of the DCS phase shifts and the TX-RX beams, any such values used in the association stage can be reutilized or refined here. Also, further channel measurements can be triggered in order to obtain new estimates of channels via DCSs (e.g., overall channels from the first FD node 602 through the first DCS 606 and the fourth DCS 612 to the second FD node 604 and from the second FD node 604 through the third DCS 610 and the second DCS 608 to the first FD node 602) and this can be used for the computation of ϕ_{d} and the TX beam and the RX beam construction in order to minimize the residual SI power level after propagation domain SI mitigation or optionally to maximize SINR (P_{SoI}/P_{SI}) power ratio. It is to be noted that any measurement computed requires only considering the DCSs in the subset dᵢ therefore, this number of measurements is already less than having to do measurements related to all DCSs which is done conventionally. Each of the first FD node 602 and the second FD node 604 is configured to update CSI or the subset dᵢ and recompute channels with the latest ϕ_{d} or trigger new channel estimation. Each of the first FD node 602 and the second FD node 604 is further configured to inform other entities of subset dᵢ.

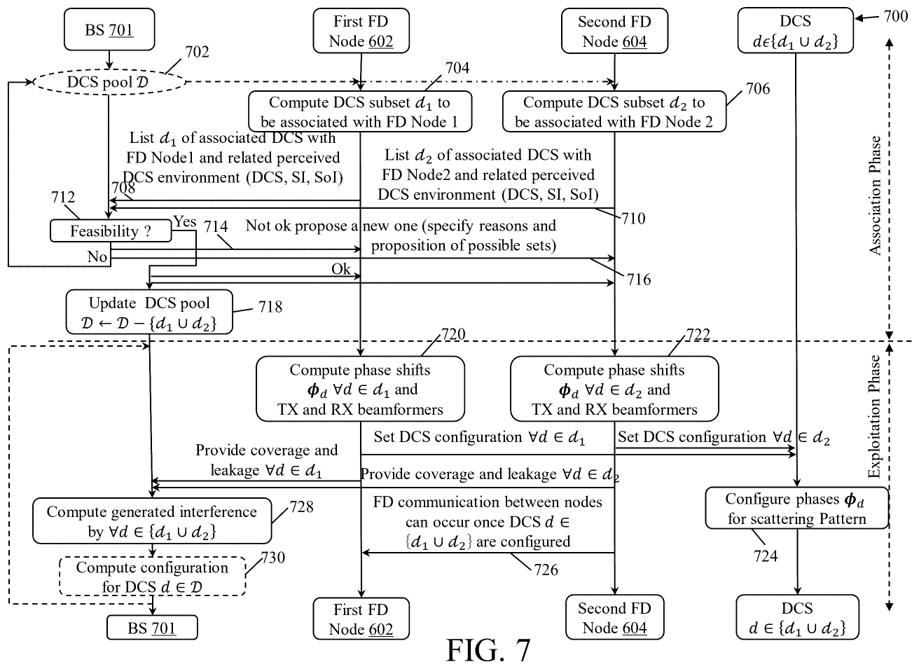

FIG. 7 is an operational flow diagram that illustrates signaling between one or more FD nodes, one or more DCSs, and an external entity, in accordance with an embodiment of the present disclosure. FIG. 7 is described in conjunction with elements from FIGS. 1, 2, 3, 4A-4E, 5, and 6A-6C. With reference to FIG. 7, there is shown a flowchart 700 that includes operations 702 to 730. The operations 704 to 730 are executed by the first FD node 602, the second FD node 604, a base station 701 and one or more DCSs, such as the first DCS 606, the second DCS 608, the third DCS 610 and the fourth DCS 612. There is further shown the base station 701 that is configured to control each of the first FD node 602 and the second FD node 604. In the flowchart 700, the communication between the first FD node 602 and the second FD node 604 may be considered as a device-to-device (D2D) communication assisted by the base station 701. In this scenario, the list of DCSs d₁ and d₂ and the related SI and SoI levels are shared with the base station 701 during the association stage.

At operation 702, the base station 701 is configured to identify an initial set of potential DCSs to be used for communication between the first FD node 602 and the second FD node 604. The initial set is denoted as a DCS pool [symbol] .

At operation 704, the first FD node 602 is configured to compute a DCS subset d₁ which is associated with the first FD node 602 for transmission and reception.

At operation 706, the second FD node 604 is configured to compute a DCS subset d₂ which is associated with the second FD node 604 for transmission and reception.

At operation 708, the first FD node 602 is configured to share the DCS subset d₁ and the related residual SI power level and optionally SoI power level to the base station 701.

At operation 710, the second FD node 604 is configured to share the DCS subset d₂ and the related residual SI power level and optionally SoI power level to the base station 701.

At operation 712, the base station 701 is configured to provide a configuration of the first FD node 602 and the second FD node 604 and the DCS subsets d₁ and d₂.

At operation 714, the provided configuration seems not feasible, and the base station 701 is configured to request the first FD node 602 to provide a new DCS subset d₁.

At operation 716, the provided configuration seems not feasible, and the base station 701 is configured to request the second FD node 604 to provide a new DCS subset d₂.

At operation 718, the provided configuration seems feasible, and the base station 701 is configured to update the initial set of DCS as [symbol] ← [symbol] —{d₁∪d₂}.

The operations 702 to 718 belong to the association stage of Algorithm 1. After execution of the association stage, the exploitation stage of Algorithm 1 is executed.

At operation 720, the first FD node 602 is configured to compute phase shift configuration ϕ_{d} ∀d∈d₁ of each DCS in the subset d₁ and TX and RX beams.

At operation 722, the second FD node 604 is configured to compute phase shift configuration ϕ_{d} ∀d∈ d₂ of each DCS in the subset d₂ and TX and RX beams.

After computation of the phase shift configuration, each of the first FD node 602 and the second FD node 604 is configured to set configuration of each DCS in the subsets d₁ and d₂, respectively. After setting the DCS configuration, each of the first FD node 602 and the second FD node 604 is configured to provide coverage area and leakage of their respective DCS subsets d₁ and d₂ to the base station 701.

At operation 724, the one or more DCSs are used to configure their scattering patterns.

At operation 726 the FD communication between the first FD node 602 and the second FD node 604 occur once the DCSs in their respective DCS subsets d₁ and d₂ are configured.

At operation 728, the base station 701 is configured to compute the generated interference by the DCSs in the subsets d₁ and d₂.

At operation 730, the base station 701 is configured to compute configurations of each DCS in the initial set, d∈ [symbol] .

The operations 720 to 730 belong to the exploitation stage of Algorithm 1.

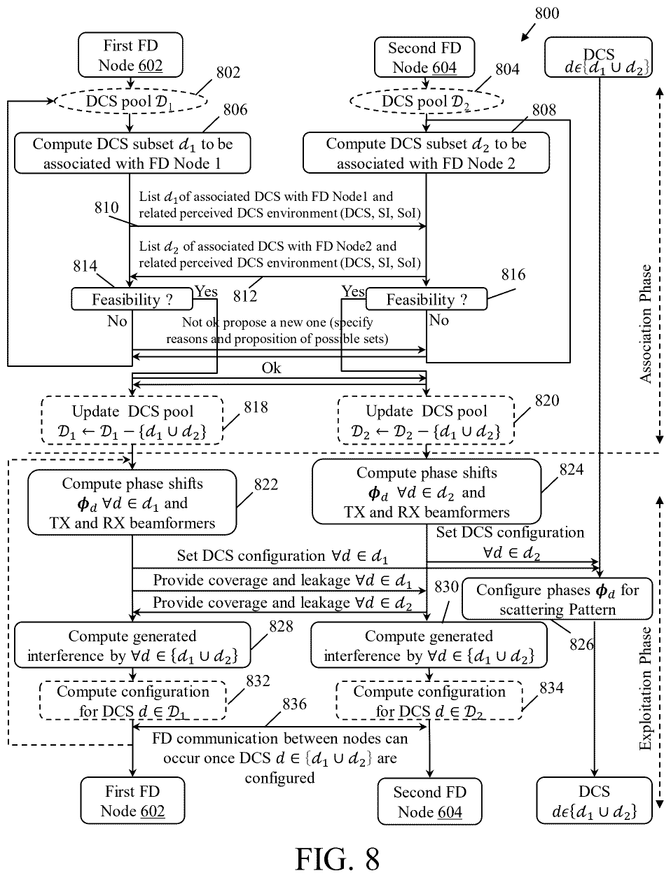

FIG. 8 is an operational flow diagram that illustrates signaling between one or more FD nodes, one or more DCSs, without using an external entity, in accordance with an embodiment of the present disclosure. FIG. 8 is described in conjunction with elements from FIGS. 1, 2, 3, 4A-4E, 5, 6A-6C, and 7. With reference to FIG. 8, there is shown a flowchart 800 that includes operations 802 to 836 which are executed by the first FD node 602, the second FD node 604 and one or more DCSs, such as the first DCS 606, the second DCS 608, the third DCS 610 and the fourth DCS 612. In this scenario, the FD nodes' operation is performed via inter-node coordination and the lists of DCSs d₁ and d₂ and the related SI and optionally SoI levels are shared between the first FD node 602 and the second FD node 604.

At operation 802, the first FD node 602 is configured to identify a first initial set of potential DCSs to be used for communication between the first FD node 602 and the second FD node 604. The first initial set is denoted as a DCS pool [symbol] ₁.

At operation 804, the second FD node 604 is configured to identify a second initial set of potential DCSs to be used for communication between the first FD node 602 and the second FD node 604. The second initial set is denoted as a DCS pool [symbol] ₂.

At operation 806, the first FD node 602 is configured to compute a DCS subset d₁ which is associated with the first FD node 602 for transmission and reception.

At operation 808, the second FD node 604 is configured to compute a DCS subset d₂ which is associated with the second FD node 604 for transmission and reception.

At operation 810, the first FD node 602 is configured to share the DCS subset d₁ and the related residual SI power level and SoI power level to the second FD node 604.

At operation 812, the second FD node 604 is configured to share the DCS subset d₂ and the related residual SI power level and SoI power level to the first FD node 602.

At operation 814, the first FD node 602 is configured to check feasibility of a configuration of the first FD node 602 and the second FD node 604 and the DCS subsets d₁ and d₂.

At operation 816, the second FD node 604 is configured to check feasibility of a configuration of the first FD node 602 and the second FD node 604 and the DCS subsets dᵢ and d₂.

In a case, if the provided configuration seems not feasible then each of the first FD node 602 and the second FD node 604 communicate a negative result (e.g., Not OK) to each other and compute new subsets d₁ and d₂. In another case, if the provided configuration seems feasible then each of the first FD node 602 and the second FD node 604 communicate a positive result (e.g., OK) to each other and proceeds further.

At operation 818, the first FD node 602 is configured to update its initial set of DCS as [symbol] ₁← [symbol] ₁—{d₁∪d₂}.

At operation 820, the second FD node 604 is configured to update its initial set of DCS as [symbol] ₂← [symbol] ₂—{d₁∪d₂}.

The operations 802 to 820 belong to the association stage of Algorithm 1.

At operation 822, the first FD node 602 is configured to compute phase shift configuration ϕ_{d} ∀d∈d₁ of each DCS in the subset d₁ and TX and RX beams.

At operation 824, the second FD node 604 is configured to compute phase shift configuration ϕ_{d} ∀d∈d₂ of each DCS in the subset d₂ and TX and RX beams.

After computation of the phase shift configuration, each of the first FD node 602 and the second FD node 604 is configured to set configuration of each DCS in the subsets d₁ and d₂, respectively. After setting the DCS configuration, each of the first FD node 602 and the second FD node 604 is configured to exchange the information about coverage area and leakage of their respective DCS subsets d₁ and d₂ to each other.

At operation 826, the one or more DCSs are used to configure their scattering patterns based on the provided phase shifts ϕ_{d}, d∈d₁∪d₂.

At operation 828, the first FD node 602 is configured to compute the generated interference by the DCS in the subsets d₁ and d₂.

At operation 830, the second FD node 602 is configured to compute the generated interference by the DCS in the subsets d₁ and d₂.

At operation 832, the first FD node 602 is configured to compute configuration of each DCS in the set d∈D₁.

At operation 834, the second FD node 604 is configured to compute configuration of each DCS in the set d∈D₂.

At operation 836, the FD communication between the first FD node 602 and the second FD node 604 occur once the DCSs in their respective DCS subsets d₁ and d₂ are configured.

The operations 822 to 836 belong to the exploitation stage of Algorithm 1.

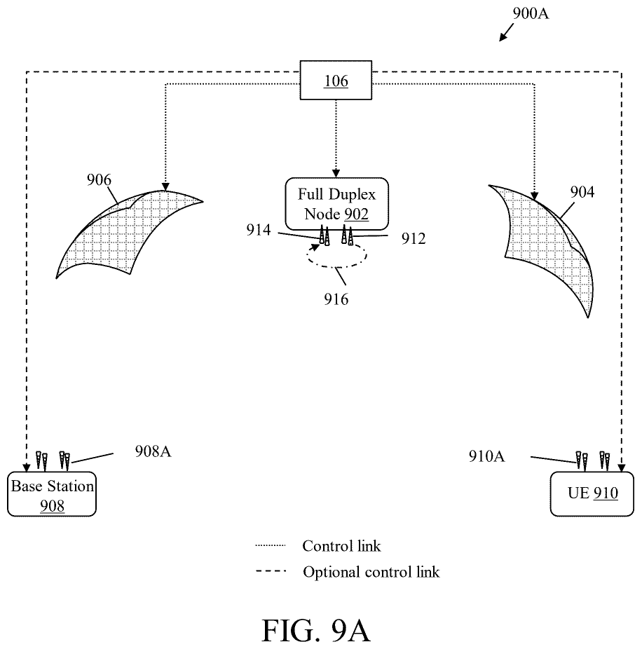

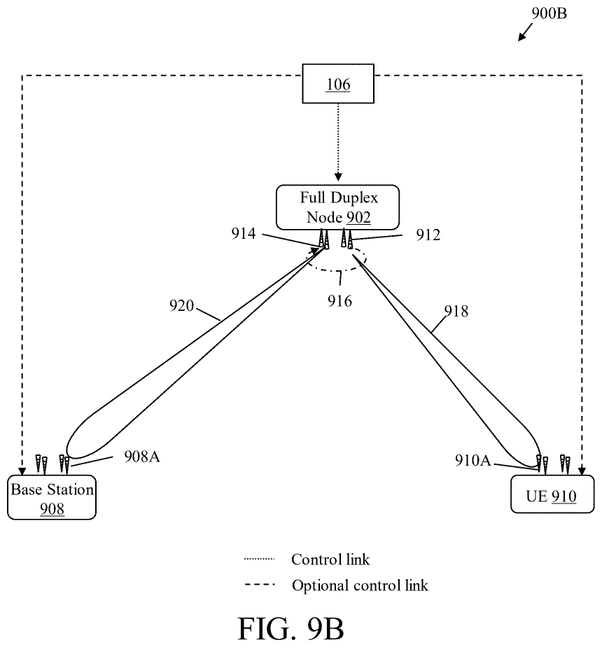

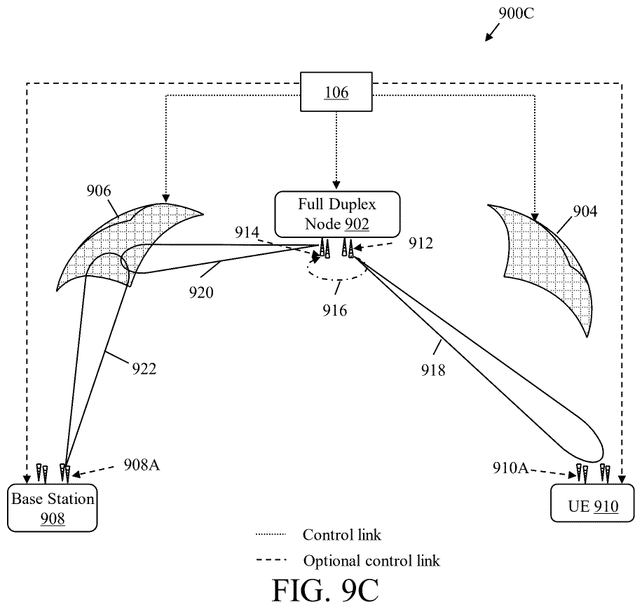

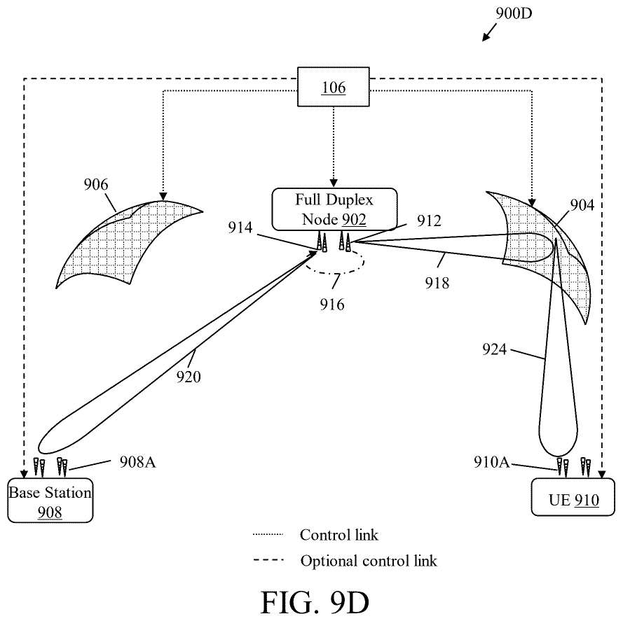

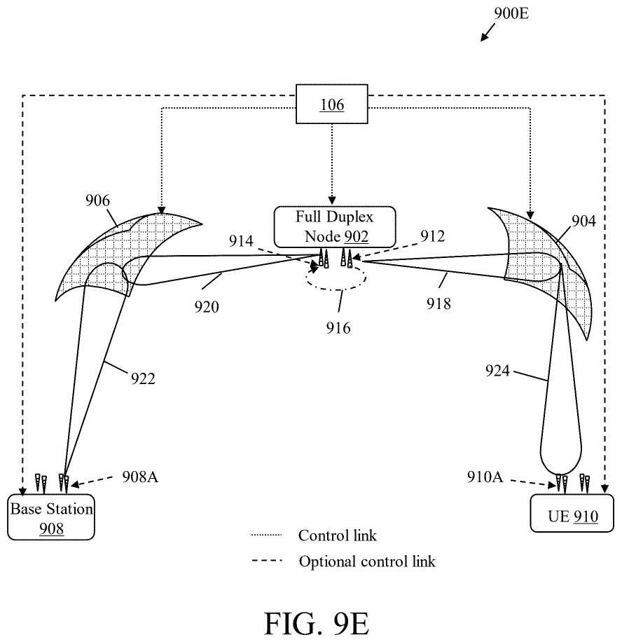

FIGS. 9A-9E collectively illustrates different deployment scenarios of one or more DCSs and a FD node in different communication systems, in accordance with different embodiments of the present disclosure. FIGS. 9A-9E are described in conjunction with elements of FIGS. 1, 2, 3, 4A-4E, and 5. With reference to FIG. 9A, there is shown a deployment scenario 900A that includes a FD node 902, a first DCS 904, a second DCS 906, a base station 908 and a UE 910. There is further shown a TX unit 912, a RX unit 914 and a self-interference (SI) signal 916 associated with the FD node 902. There is further shown a transmitter unit 908A associated with the base station 908 and a receiver unit 910A associated with the UE 910.

The FD node 902 is configured to perform integrated access and backhaul (IAB). The FD node 902 is configured to provide access to the UE 910 as well as perform a wireless backhaul connection to the base station 908. The FD node 902 uses same time and frequency resources for access and backhaul. The FD node 902 may also be referred to as a FD IAB node.

The controller 106 is configured to execute Algorithm 1. The following inputs are considered for execution of Algorithm 1: an estimation of a non-DCS channel from the base station 908 to the FD node 902 (H_{BS-IAB}), an estimation of a non-DCS channel from the FD node 902 to the UE 910 (H_{IAB-UE}), an estimation of locations of the first DCS 904 and the second DCS 906, an estimation of location of the FD node 902, an estimation of location of the base station 908, number of DCSs used, D=2 are used for different deployment scenarios, (described in detail, for example, in FIGS. 9C to 9E), a target residual SI power level after propagation domain SI mitigation T_{SI}, a constraint on the residual, for example, the residual must be less than or equal to the target T_{SI}. The different stages of Algorithm 1, such as the association stage and the exploitation stage are described in detail, for example, in FIGS. 9B to 9E.

Algorithm 1 is implemented in FIGS. 9B-9E in a similar way as implemented in FIGS. 4B-4E with a few differences. The few differences being that a typical implementation of the FD node 902 (i.e., IAB node) has following features. (i) Besides the FD node 902, the first DCS 904 and the second DCS 906, the base station 908 is also fixed, so the base station 908 fixed location nature may also be used by Algorithm 1. Since the FD node 902, the first DCS 904, the second DCS 906 and the base station 908 are fixed, this facilitates assessing the effect of communicating from the base station 908 to the FD node 902 when assisted by the second DCS 906. The reason being the related channels are varying in a slower scale in comparison to channels from the FD node 902 to the UE 910 which vary more rapidly due to the perceived propagation environment. Alternatively stated, the channel from the base station 908 to the second DCS 906 and the channel from the second DCS 906 to the FD node 902 (i.e., IAB node) correspond to channels between static nodes hence, the channels may vary in slower time scale than the channel from the FD node 902 to the UE 910 or the channel from the first DCS 904 to the UE 910. (ii) The operation of the FD node 902 is controlled by the base station 908 (this is common to IAB scenarios) hence, the signaling exchanges are different from the ones that have previously been described, for example, in FIG. 5.

In the association stage, the FD node 902 is configured to use the knowledge of the base station 908 to the FD node 902 non-DCS channel, H_{BS-AB} (or knowledge of the location of the base station 908 and the FD node 902), and knowledge of the FD node 902 to the UE 910 non-DCS channel, H_{IAB-UE}, for assessing the resulting residual SI power level after propagation domain mitigation P_{SI} when using a TX and a RX beamformer at the FD node 902 when no DCS is used. The residual SI power level P_{SI} is compared against the target residual T_{SI} and there are following two possible outcomes. A first outcome is obtained when the residual SI power level meets the required constraint (P_{SI}≤T_{SI}) then, the association stage gives as an output that DCS is not required for communication of the FD node 902 and the association stage ends providing the subset dᵢ of DCS as an empty set (dᵢ=θ). A second outcome is obtained when the residual SI power level does not meet the required constraint (P_{SI22} T_{SI}) and the FD node 902 is configured to consider, as part of the association stage of Algorithm 1, the DCS as described in detail, for example, in FIG. 9C. The first outcome of the association stage of Algorithm 1 with the subset dᵢ of DCS as an empty set (dᵢ=θ) is illustrated in FIG. 9B.

Now referring to FIG. 9B, there is shown a communication system 900B that includes a TX beam 918 and a RX beam 920 at the FD node 902. In the communication system 900B, no DCS is used for communication with the FD node 902. Instead of DCS, the TX beamformer and resulting TX beam 918 and the RX beamformer and the resulting RX beam 920 are used for enhancement of transmission and reception at the FD node 902, respectively. The TX beam 918 is used for transmission from the FD node 902 to the UE 910. The RX beam 920 is used for reception at the FD node 902 from the base station 908.

Now referring to FIG. 9C, there is shown a communication system 900C that includes the FD node 902, the second DCS 906, the base station 908, and the RX beam 920. There is further shown a base station TX beam 922 at the base station 908.

For the scenario shown in FIG. 9B, if the residual SI power level does not meet the required constraint (P_{SI}>T_{SI}) then the association stage of the Algorithm 1 continues and considers DCSs as depicted on FIG. 9C because the UE 910 lies in a problematic region and cannot be served by the FD node 902 (i.e., IAB node) directly due to large SI (e.g., the SI signal 916). Therefore, the FD node 902 is configured by 106 to consider for use the available DCSs in FIG. 9C. Thus, the association stage of Algorithm 1 continues and considers the use of the second DCS 906 in order to assist communication at the FD node 902 over the slower varying channel, which is the channel between the base station 908 and the FD node 902. The reason for the slower varying channel being that the location of the FD node 902 and the base station 908 are fixed. This choice of considering the use of the second DCS 906 at this point in the Algorithm 1 is made since available channel estimates can be more accurate for slower varying channels. The algorithm first considers use of the second DCS 906 in order to assist the base station 908 to the FD node 902 (i.e., IAB node) communication. Therefore, one possibility is, the second DCS 906 is chosen first because it is identified to be the closest to the base station 908. The algorithm thus proceeds to assess the resulting residual SI after propagation domain mitigation when using the RX beam 920 at the FD node 902 to receive the signal from the second DCS 906 and the TX beam 918 at the FD node 902 to send the signal towards the UE 910. This assessment can be done using the knowledge of the non-DCS access channel H_{IAB-UE} and the knowledge of backhaul channel via the second DCS 906 which can be obtained for example, from previous channel estimates for the channel between the second DCS 906 and the FD node 902. Another possibility is also there to use the direction of signal departure from FD node 902 to the UE 910 and direction of signal arrival from the second DCS 906 to the FD node 902 to assess the closeness of departure and arrival angles and map this to an expected SI residual power level. The obtained residual SI power level after propagation domain mitigation by use of the second DCS 906 is compared against the target constraint and there are the following two possible outcomes. A first outcome is obtained when the residual SI power level meets the required constraint (P_{SI}≤T_{SI}) then, the association stage gives as an output that the second DCS 906 is required and the association stage ends providing the subset dᵢ of DCSs as dᵢ={the second DCS 906}. A second outcome is obtained when the residual SI power level does not meet the required constraint (P_{SI}>T_{SI}) and the FD node 902 is configured to consider, as part of the association stage of Algorithm 1, the DCS as described in detail, for example, in FIG. 9D. The first outcome of the association stage of Algorithm 1 with the subset dᵢ of DCSs as dᵢ{the second DCS 906} is illustrated in the FIG. 9C. As shown in FIG. 9C, the other base station TX beam 922 is used to send the signal from the base station 908 and the RX beam 920 is used to receive the signal from the second DCS 906 to the FD node 902. Additionally, the TX beam 918 is used to communicate the signal from the FD node 902 to the UE 910.

Now referring to FIG. 9D, there is shown a communication system 900D that includes the FD node 902, the first DCS 904, the UE 910, and the TX beam 918. There is further shown another DCS scattered beam 924.

For the scenario shown in FIG. 9C, the residual SI power level does not meet the required constraint (P_{SI}>T_{SI}), then, the association stage of the Algorithm 1 considers the FD node 902 configured to use the first DCS 904 due to, for example, its proximity with the TX unit 912 of the FD node 902, as shown in the scenario in FIG. 9D. The first DCS 904 is considered by the association stage of the Algorithm 1 for enhancing the transmission at the FD node 902 as shown in FIG. 9D. The resulting residual SI power level is assessed after propagation domain mitigation when using the TX beam 918 at the FD node 902 (i.e., the IAB node) towards the first DCS 904 and the RX beamformer 920 to receive the signal from the base station 908. This can be done using knowledge of location of the first DCS 904 and backhaul channel H_{BS-IAB} non-DCS channel. The obtained residual is compared against the target constraint and there are the following two possible outcomes. A first outcome is obtained when the residual SI power level meets the required constraint (P_{SI}≤T_{SI}) then, the association stage gives as an output that the first DCS 904 is required and the association stage ends providing the subset dᵢ of DCS as dᵢ{the first DCS 904}. A second outcome is obtained when the residual SI power level does not meet the required constraint (P_{SI}>T_{SI}) and the FD node 902 is configured to consider, as part of the association stage of Algorithm 1, the DCSs as described in detail, for example, in FIG. 9E. The first outcome of the association stage of Algorithm 1 with the subset dᵢ of DCS as dᵢ={the first DCS 904} is illustrated in the FIG. 9D. As shown in FIG. 9D, the TX beam 918 is used to assist the transmission at the FD node 902 towards the first DCS 904 and the DCS scattered beam 924 is used for transmission of the signal from the first DCS 904 towards the UE 910. Additionally, the RX beamformer 920 is used to assist the reception of the FD node 902 from the base station 908.

Now referring to FIG. 9E, there is shown a communication system 900E that includes the FD node 902, the first DCS 904, the second DCS 906, the base station 908, the UE 910, the TX beam 918, the RX beam 920, the base station beam 922 and the other DCS scattered beam 924 by the second DCS 904.

For the scenario shown in FIG. 9D, the residual SI power level does not meet the required constraint (P_{SI}>T_{SI}), the association stage of the Algorithm 1 considers the FD node 902 configured to use the first DCS 904 and the second DCS 906 as shown in the scenario of FIG. 9E. The first DCS 904 is used to assist the transmission at the FD node 902 towards the UE 910 and the second DCS 906 is used to assist the reception at the FD node 902 from the base station 908. The resulting residual SI power level is assessed after propagation domain mitigation when using the TX beam 918 at the FD node 902 towards the first DCS 904 and the RX beam 920 at the FD node 902 to receive the signal from the second DCS 906. This assessment can, for example, be done using the knowledge of locations of the first DCS 904 and the second DCS 906 or, if available, previous channel estimates for the channel between the FD node 902 and the first DCS 904 and the second DCS 906. The obtained residual SI power level after propagation domain mitigation using the first DCS 904 and the second DCS 906 is compared against the target constraint and there are the following two possible outcomes. A first outcome is obtained when the residual SI power level meets the required constraint (P_{SI}≤T_{SI}) then, the association stage gives as an output that the first DCS 904 and the second DCS 906 are required for enhancement of transmission and reception at the FD node 902 and the association stage ends providing the subset dᵢ of DCS as dᵢ={the first DCS 904 and the second DCS 906}, which is illustrated in the communication system 900E. A second outcome is obtained when the residual SI power level does not meet the required constraint (P_{SI}>T_{SI}) then, the association stage of Algorithm 1 provides the assessment that the FD communication is unfeasible given the target residual SI power T_{SI}. The outcome of the association stage of Algorithm 1 with the subset dᵢ of DCS as dᵢ={the first DCS 904 and the second DCS 906} is illustrated in the communication system 900E. As shown in FIG. 9E, the first DCS 904, and the second DCS 906 along with the TX beam 918, the RX beam 920, the DCS scattered beam 924 by the first DCS 904 and the base station TX beam 922 are used for communication at the FD node 902.

The association stage just described provides an example embodiment of a possible order of assessing the different possible configurations. In this example the order of configurations to consider was configuration in FIG. 9B, then configuration in FIG. 9C, then FIG. 9D, followed by FIG. 9E. This order can be changed in other possible embodiments of the Algorithm 1, where for example assessment of configurations in FIG. 9C and FIG. 9D are reversed with respect to the order considered in the previous example embodiment, or are parallelized. The assessment for configuration in FIG. 9E can be considered as an extra step to the assessment in FIG. 9C or FIG. 9D or the parallelized version, as well as a first step without any of the previous assessments.

After execution of the association stage of Algorithm 1, which has been described in detail, for example, in FIGS. 9A-9E, the FD node 902 is configured to execute the exploitation stage of Algorithm 1. In order to execute the exploitation stage of Algorithm 1, the FD node 902 is configured to compute phase shift configuration ϕ_{d} of each DCS d∈dᵢ. The FD node 902 is further configured to compute the TX beam 918 and the RX beam 920 at the FD node 902 while taking into account the target residual SI power level T_{SI}. In computation of the phase shift configuration and TX-RX beams, any such values used in the association stage can be reutilized or refined here. Also, further channel measurements can be triggered in order to obtain new estimates of channels for example via the first DCS 904 and the second DCS 906 (e.g., overall channels from the base station 908 through the second DCS 906 to the FD node 902 and from the FD node 902 through the first DCS 904 to the UE 910) and this can be used for computation of ϕ_{d} and the TX beam 918 and the RX beam 920 in order to minimize the residual SI power level after propagation domain SI mitigation or optionally to maximize SINR (P_{SoI}/P_{SI}) power ratio. It is to be noticed that any measurement computed requires only the DCSs in the subset dᵢ therefore, this number of DCSs is already less than having to do measurements related to all DCSs which is done conventionally. The FD node 902 is configured to update CSI or the subset dᵢ and recompute channels with the latest phase shifts ϕ_{d} or trigger new channel estimation. The FD node 902 is further configured to inform other entities of the DCS subset dᵢ.

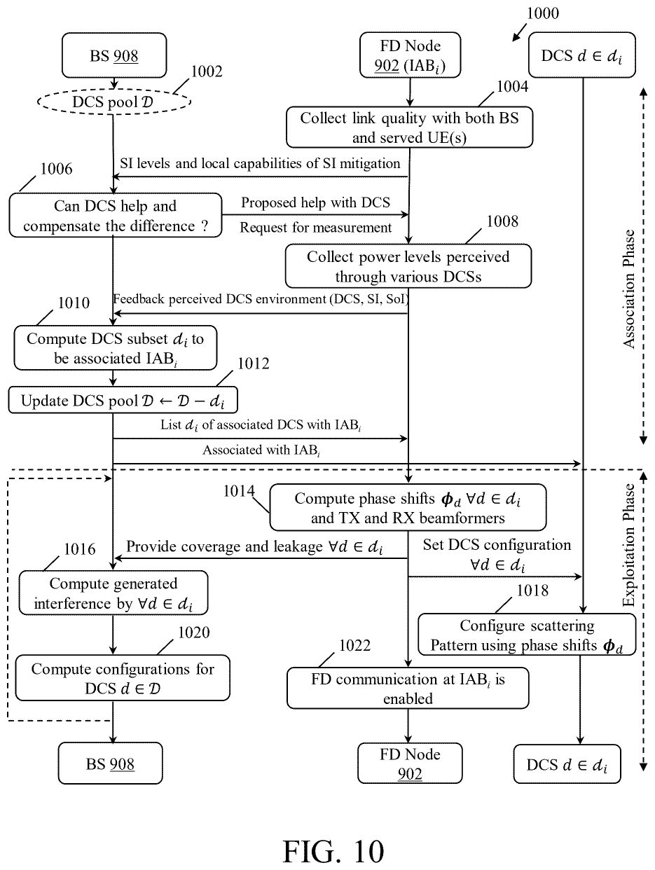

FIG. 10 is an operational flow diagram that illustrates signaling between a FD node, one or more DCSs, and a base station, in accordance with an embodiment of the present disclosure. FIG. 10 is described in conjunction with elements from FIGS. 1, 2, 3, 4A-4E, 5, and 9A-9E. With reference to FIG. 10, there is shown a flowchart 1000 that includes operations 1002 to 1022 which are executed by the FD node 902, one or more DCSs, such as the first DCS 904, the second DCS 906, and the base station 908.

In the flowchart 1000, the FD node 902 (i.e., IAB node) is controlled by the base station 908. Moreover, the subset of DCS dᵢ is defined by the base station 908 and the phase shift of each DCS ϕ_{d} and the TX beam 918 and the RX beam 920 are computed at the FD node 902. In the flowchart 1000, for correct configurations and computations, signaling exchanges involving DCS and related SI information (and optional SoI information) are required for correct operation.

At operation 1002, the base station 908 is configured to identify an initial set of potential DCSs to be used for communication between the FD node 902, the base station 908 and the UE 910. The initial set is denoted as a DCS pool [symbol] .

At operation 1004, the FD node 902 is configured to collect link quality from the base station 908 and the UE 910. After collecting the link quality, the FD node 902 is configured to share the SI power levels and local capabilities of SI mitigation to the base station 908.

At operation 1006, the base station 908 is configured to decide whether the use of the first DCS 904 and/or the second DCS 906 or no DCS can compensate the difference of SI power levels with the target constraint. For this, the base station 908 is further configured to ask for measurements from the FD node 902.

At operation 1008, the FD node 902 is configured to collect power levels (e.g., estimated budget gains) perceived through various DCSs, for example, the first DCS 904 and the second DCS 906. After that, the FD node 902 is configured to share the feedback perceived DCS environment (e.g., DCS, SI, SoI power levels) to the base station 908.

At operation 1010, the base station 908 is configured to compute a DCS subset dᵢ to be associated with the FD node 902.

At operation 1012, the base station 908 is configured to update the initial set of DCS as [symbol] ← [symbol] —dᵢ. The base station 908 is further configured to share the updated list of DCS dᵢ to the FD node 902.

The operations 1002 to 1012 belong to the association stage of Algorithm 1. After that, the exploitation stage of Algorithm 1 is executed.

At operation 1014, the FD node 902 is configured to compute phase response ϕ_{d} ∀_{d} ∈ dᵢ of each DCS in the subset dᵢ as well as the TX beamformer resulting in the TX beam 918 and the RX beamformer resulting in the RX beam 920. The FD node 902 is configured to exchange the information about coverage area and leakage of the DCS subset dᵢ to the base station 908. The FD node 902 is also configured to set DCS configuration ϕ_{d}∀d ∈dᵢ to the first DCS 904 and the second DCS 906.

At operation 1016, the base station 908 is configured to compute the generated interference by the DCS in the subset dᵢ.

At operation 1018, the one or more DCSs are used to configure their scattering patterns.

At operation 1020, the base station 908 is configured to compute configuration of each DCS in the set [symbol] .

At operation 1022, the FD communication at the FD node 902 is enabled.

The operations 1014 to 1022 belong to the exploitation stage of Algorithm 1.

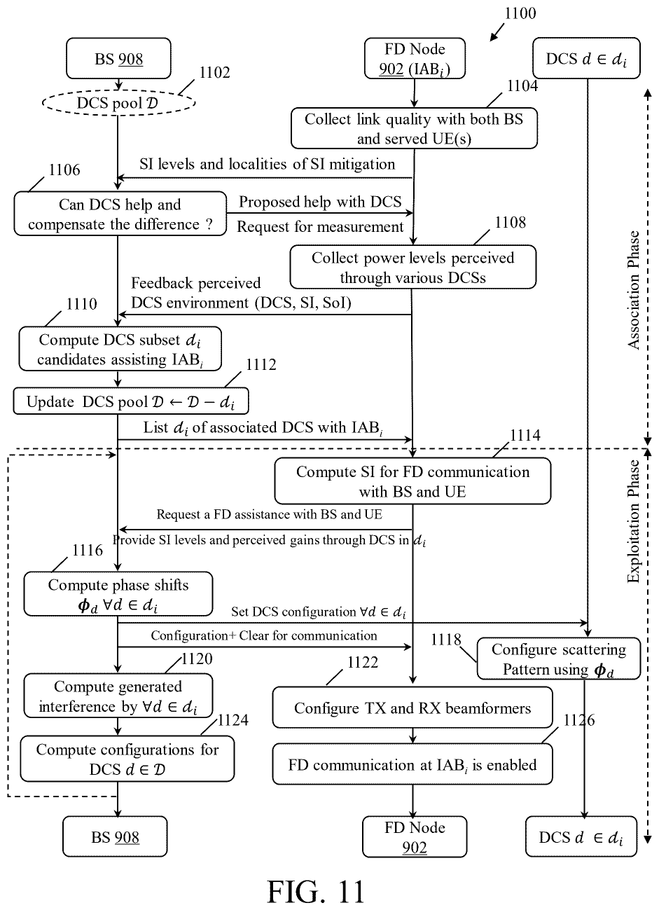

FIG. 11 is an operational flow diagram that illustrates signaling between a FD node, one or more DCSs, and a base station, in accordance with another embodiment of the present disclosure. FIG. 11 is described in conjunction with elements from FIGS. 1, 2, 3, 4A-4E, 5, 9A-9E and 10. With reference to FIG. 11, there is shown a flowchart 1100 that includes operations 1102 to 1126 which are executed by the FD node 902, one or more DCSs, such as the first DCS 904, the second DCS 906, and the base station 908.

In the flowchart 1100, the FD node 902 (i.e., IAB node) is controlled by the base station 908. Moreover, the subset of DCS dᵢ and the TX beamformer and related TX beam 918 and the RX beamformer and related RX beam 920 are computed at the FD node 902 and the phase response is computed at the base station 908. In the flowchart 1100, for correct configurations and computations, signaling exchanges involving DCS and related SI information (and optional SoI information) are required for correct operation.

At operation 1102, the base station 908 is configured to identify an initial set of potential DCSs to be used for communication between the FD node 902, the base station 908 and the UE 910. The initial set is denoted as a DCS pool [symbol] .

At operation 1104, the FD node 902 is configured to configured to collect link quality from the base station 908 and the UE 910. After collecting the link quality, the FD node 902 is configured to share the SI power levels and local capabilities of SI mitigation to the base station 908.

At operation 1106, the base station 908 is configured to decide whether the use of the first DCS 904 and/or the second DCS 906 or no DCS can compensate the difference of SI power levels with the target constraint. For this, the base station 908 is further configured to ask for measurements from the FD node 902.

At operation 1108, the FD node 902 is configured to collect power levels (e.g., estimated budget gains) perceived through various DCSs, for example, the first DCS 904 and the second DCS 906. After that, the FD node 902 is configured to share and thus feedback perceived DCS environment (e.g., DCS, SI, SoI power levels) to the base station 908.

At operation 1110, the base station 908 is configured to compute a DCS subset dᵢ to be associated with the FD node 902.

At operation 1112, the base station 908 is configured to update the initial set of DCS as [symbol] ← [symbol] —dᵢ. The base station 908 is further configured to share the updated list of DCS dᵢ to the FD node 902.

The operations 1102 to 1112 belong to the association stage of Algorithm 1. After that, the exploitation stage of Algorithm 1 is executed.

At operation 1114, the FD node 902 is configured to compute SI power level for FD communication with base station and UE. Thereafter, the FD node 902 is configured to request FD assistance from the base station 908. The FD node 902 is further configured to provide SI levels and perceived gains through DCS in the subset dᵢ.

At operation 1116, the base station 908 is configured to compute radiation pattern ϕ_{d} ∀d ∈dᵢ of each DCS in the subset dᵢ. The base station 908 is configured to set DCS configuration ϕ_{d}∀d∈dᵢ.

At operation 1118, the one or more DCSs are used to configure their scattering patterns.

At operation 1120, the base station 908 is configured to compute the generated interference by the DCS in the subset dᵢ.

At operation 1122, the FD node 902 is used to configure the TX beamformer for generating the TX beam 918 and the RX beamformer for generating the RX beam 920.

At operation 1124, the base station 908 is configured to compute configuration of each DCS in the set [symbol] .

At operation 1126, the FD communication at the FD node 902 is enabled.

The operations 1114 to 1126 belong to the exploitation stage of Algorithm 1.

In a yet another implementation scenario, where the FD node 902 is configured to perform the integrated access and backhaul wireless communication, the SoI information is used in order to compute the subset dᵢ and the final DCS phases and beamformers. It is to be noticed that the use of SoI information and optimization problem formulation is not limited to this implementation scenario however, such formulation is applicable to the other scenarios, which have been described, for example, in FIGS. 4A and 6A, where a FD node serves an uplink and a downlink user and two FD nodes communicate with each other, respectively.

For the implementation scenario where the SoI information is used in order to compute the subset dᵢ and the final DCS phases and beamformers, following inputs are considered for execution of Algorithm 1: (i) Total number of DCS (D). (ii) A target residual SI power level after propagation domain SI mitigation, T_{SI}. (iii) A constraint on the residual: the residual must be less than or equal to the target, T_{SI}. The implementation of the association stage is performed via an optimization problem that assesses the residual SI power level P_{SI} and also the received power of the incoming SoI at the FD node 902 (i.e., IAB node) denoted as P_{SoI}. The output of the association stage is the solution to the following optimization problem given by Equation (2)

$${d}_{i} = arg {max}_{d ⊆ \{ 1 , … , D \} \vert {P}_{SI} ( d ) \leq {T}_{SI}} {P}_{SoI} ( d ) \qquad ( 2 )$$

The assessment of P_{SoI} and P_{SI} for a given subset d can be performed, for example, via simple link budget measurement that includes a signal sent by the base station 908 for P_{SoI} assessment. It is emphasized that a link budget measurement is much easier to perform than a channel estimation measurement. Moreover, in the exploitation stage, an optimization problem is solved in order to compute the phase shift configuration ϕ_{d}* for DCS d∈dᵢ, a TX beamformer V* and a RX beamformer U* at the FD node 902 so that the incoming signal of interest at the FD node 902 is maximized and the constraint on the residual is accounted for as given in Equation (3)

$$\{ {ϕ}_{d}^{*} , {V}^{*} , {U}^{*} \} = arg {max}_{{ϕ}_{d ∀ d ∈ {d}_{i} ,} , V , U} {P}_{SoI} ( {ϕ}_{d} , V , U ) \qquad ( 3 )$$

$$s . t . {P}_{SI} \leq {T}_{SI}$$

FIG. 12 is an operational flow diagram that illustrates signaling between a FD node, one or more DCSs, and a base station, in accordance with yet another embodiment of the present disclosure. FIG. 12 is described in conjunction with elements from FIGS. 1, 2, 3, 4A-4E, 5, 9A-9E, 10 and 11. With reference to FIG. 12, there is shown a flowchart 1200 that includes operations 1202 to 1218 which are executed by the FD node 902, one or more DCSs, such as the first DCS 904, the second DCS 906, and the base station 908.

In the flowchart 1200, the FD node 902 (i.e., IAB node) is controlled by the base station 908. Moreover, the subset of DCS dᵢ is defined by the base station 908 and the phase shift ϕ_{d} of each DCS and the TX beamformer that results in the TX beam 918 and the RX beamformer that results in the RX beam 920 are computed at the FD node 902.

At operation 1202, the base station 908 is configured to identify an initial set of potential DCSs to be used for communication between the FD node 902, the base station 908 and the UE 910. The initial set is denoted as a DCS pool [symbol] . The base station is further configured to transmit a signal for P_{SoI} link budget assessment.

At operation 1204, the FD node 902 is configured to collect power levels (e.g., estimated budget gains) perceived through various DCSs, for example, the first DCS 904 and the second DCS 906. After that, the FD node 902 is configured to share the feedback perceived DCS environment (e.g., DCS, SI, SoI power levels) to the base station 908.

At operation 1206, the base station 908 is configured to compute a DCS subset dᵢ to be associated with the FD node 902.

At operation 1208, the base station 908 is configured to update the initial set of DCS as [symbol] ← [symbol] —dᵢ. The base station 908 is further configured to share the updated list of DCS dᵢ to the FD node 902.

The operations 1202 to 1208 belong to the association stage of Algorithm 1. After that, the exploitation stage of Algorithm 1 is executed.

At operation 1210, the FD node 902 is configured to compute phase shift configuration ϕ_{d} ∀d∈dᵢ of each DCS in the subset dᵢ as well as the TX beamformer that results in the TX beam 918 and the RX beamformer that results in the RX beam 920. The FD node 902 is configured to exchange the information about coverage area and leakage of the DCS subset dᵢ to the base station 908. The FD node 902 is also configured to set DCS configuration ∀d∈dᵢ to the first DCS 904 and the second DCS 906.

At operation 1212, the base station 908 is configured to compute the generated interference by the DCS in the subset dᵢ.

At operation 1214, the one or more DCSs (e.g., the first DCS 904 and the second DCS 906) are used to configure their scattering patterns.

At operation 1216, the base station 908 is configured to compute configuration of each DCS in the set [symbol] .

At operation 1218, the FD communication at the FD node 902 is enabled.

The operations 1210 to 1218 belong to the exploitation stage of Algorithm 1.

Additionally, in an alternative implementation scenario of the case where the SoI information is used in order to compute the subset dᵢ and the final DCS phases and beamformers, the optimization problems described in Equation (2) and Equation (3) can also be solved by taking into account the SoI power at the FD node's intended receiver (e.g., the UE 910), denoted as P_{SoI,FDIR} as part of an objective function. That means changing the objective P_{SoI} in Equation (2) and Equation (3) to ƒ(P_{SoI}, P_{SoI,FDIR}) and function ƒ(, ) can be any meaningful function as desired, for example, simply given by ƒ(P_{SoI}, P_{SoI,FDIR})=P_{SoI}+P_{SoI,FDIR}. The assessment of P_{SoI,FDIR} can be performed for example, via simple link budget measurement from a signal sent by the UE 910 hence, this signal would be additional to the ones shown in FIG. 12. The alternative implementation scenario is also applicable to the other scenarios, have been described, for example, in FIGS. 4A and 6A, where a FD node serves an uplink and a downlink user and two FD nodes communicate with each other, respectively.

For yet another implementation scenario using SoI, following inputs are considered for execution of Algorithm 1: (i) Total number of DCS ( [symbol] ). (ii) A target residual SI power level after propagation domain SI mitigation, T_{SI}. (iii) A constraint on the residual: the residual must be less than or equal to the target, T_{SI}. (iv) Target SINR T_{SINR} at the FD node 902, the SINR is assessed by computing P_{SoI}/P_{SI} where P_{SoI} is the received power of the incoming signal of interest at the FD node 902 and P_{SI} is the residual SI power level after propagation domain SI mitigation

The implementation of the association stage is performed via an optimization problem that minimizes the residual SI power level P_{SI} while meeting the constraint on the target SINR. The output of the association stage is the solution to the following optimization problem given by Equation (4)

$${d}_{i} = arg {max}_{d ⊆ \{ 1 , … , D \} \vert {P}_{SI} ( d ) \leq {T}_{SI}} {P}_{SI} ( d ) \qquad ( 4 )$$

$$s . t . ( {P}_{SoI} / {P}_{SI} ) \geq {T}_{SINR}$$

The assessment of P_{SoI} and P_{SI} for a given subset dᵢ can be performed, for example, via simple link budget measurement that includes a signal sent by the base station 908 for P_{SoI} assessment. If the output of Equation (4) is an empty set then this means that a DCS is not required to meet the target residual T_{SI}. For the case where we cannot find a set such that P_{SI} (d)≤T_{SI} (in other words, subset dᵢ does not exist) then this means that the FD communication with the given target residual constraint T_{SI} is not feasible. If such is the case one solution could be to change (increase) the target residual and search again for subset dᵢ. Another solution could be to change from FD to other type of communication (for example half duplex) if increasing T_{SI} is not possible since it would result in P_{SI} so strong that any FD communication is impossible.

In the exploitation phase, an optimization problem is solved in order to compute the phase shift configuration ϕ_{d}* for DCS d∈dᵢ, a TX beamformer V* and a RX beamformer U* at the FD node 902 so that the residual SI power level P_{SI} is minimized while meeting the constraint on target SINR given by Equation (5)

$$\{ {ϕ}_{d}^{*} , {V}^{*} , {U}^{*} \} = arg {max}_{{ϕ}_{d ∀ d ∈ {d}_{i} ,} , V , U} {P}_{SI} ( {ϕ}_{d} , V , U ) \qquad ( 5 )$$

$$s . t . ( {P}_{SoI} / {P}_{SI} ) \geq {T}_{SINR}$$

The implementation scenario can also be optionally extended by adding a constraint T_{SoI,FDIR} on the SoI power at the FD node's intended receiver (e.g., the UE 910), denoted as P_{SoI,FDIR}. The constraint is expressed as P_{SoI,FDIR}≥T_{SoI,FDIR} and can be added to Equation (4) and Equation (5).

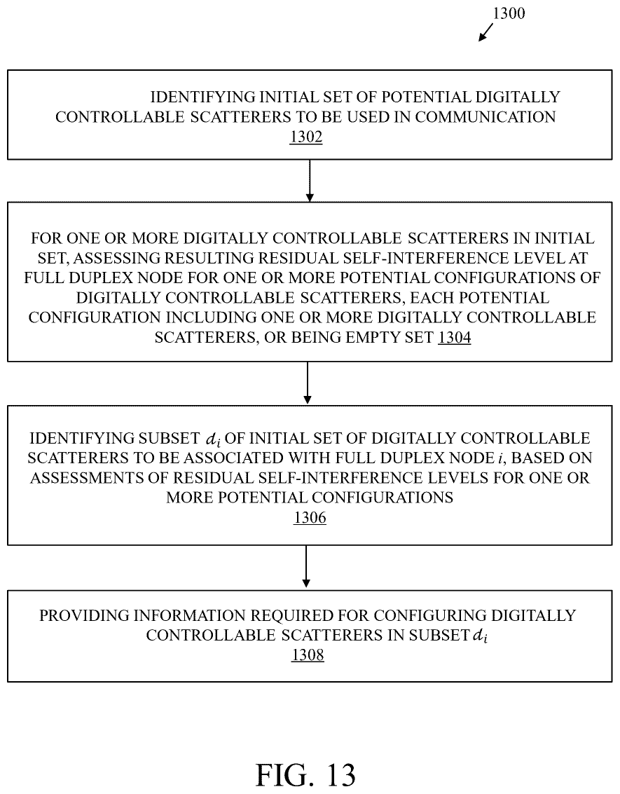

FIG. 13 is a flowchart of a method for use in a wireless communication network, in accordance with an embodiment of the present disclosure. FIG. 13 is described in conjunction with elements from FIGS. 1, 2, 3, 4A-4E, 5, 6A-6C, 7, 8, 9A-9E, 10, 11, and 12. With reference to FIG. 13, there is shown a method 1300 that includes steps 1302 to 1308. The method 1300 is executed by the FD node 102 and its alternative forms (e.g., the first FD node 602, the second FD node 604 and the FD node 902), the control unit 106, a transmitter (e.g., the TX UE 302, or a base station or a UE) and a receiver (e.g., the RX UE 304).

There is provided the method 1300 for use in a wireless communications network. The wireless communication network may include a full duplex node (e.g., the FD node 102) including a transmitter unit (e.g., the transmitter unit 108) and a receiver unit (e.g., the receiver unit 110), a set of one or more digital controllable scatterers (e.g., the first DCS 104A and the second DCS 104B), a transmitter (e.g., the TX UE 302) and a receiver (e.g., the RX UE 304). The transmitter unit 108 and the receiver unit 110 of the FD node 102 are coupled in such a way that a transmitted signal generates a residual self-interference at the receiver unit 110. The method comprises an assessment stage including the steps of 1302 to 1308.

At step 1302, the method 1300 comprises identifying an initial set of potential digitally controllable scatterers to be used in the communication. The initial set of potential digitally controllable scatterers (DCSs) that can potentially support signal transmission and reception at the FD node 102 is identified.

In accordance with an embodiment, the initial set can be selected based on the distance between the digitally controllable scatterers and the full duplex node 102. The selection of the initial set can be based on the location information related to the location of DCSs (e.g., DCS with a distance from the FD node 102 or other node that is greater than a specified value).

At step 1304, the method 1300 further comprises for one or more digitally controllable scatterers in the initial set, assessing a resulting residual self-interference level at the full duplex node 102 for one or more potential configurations of the digitally controllable scatterers, each potential configuration including one or more digitally controllable scatterers, or being an empty set. For the one or more DCSs identified in the initial set, the one or more potential configurations of the DCSs (e.g., choice of DCSs and optionally phase shift configuration) are considered for transmission support as well as reception support at the FD node 102. For each potential configuration of the DCSs, the resulting residual self-interference (SI) level is assessed after propagation domain SI mitigation is performed.

In accordance with an embodiment, the step of assessing the level of self-interference can be performed based on the location of the digitally controllable scatterer and/or a characteristic of a beacon associated with the digitally controllable scatterer. In an implementation, the resulting residual self-interference level can be assessed based on the location information related to the location of the DCSs identified in the initial set. In another implementation, the resulting residual self-interference level can be assessed based on the characteristic of the beacon associated with the DCS.

At step 1306, the method 1300 further comprises identifying a subset dᵢ of the initial set of digitally controllable scatterers to be associated with the full duplex node i (i.e., the FD node 102), based on the assessments of residual self-interference levels for the one or more potential configurations. After assessing the resulting residual SI level, the subset dᵢ of the initial set of DCSs is identified, which can be associated for communication of the FD node 102. The subset dᵢ of the initial set of DCSs is identified by taking into account a target residual SI power level T_{SI} after propagation domain mitigation.

At step 1308, the method 1300 further comprises providing information required for configuring the digitally controllable scatterers in the subset dᵢ. In an implementation, the subset dᵢ of DCSs can be obtained by using the information about the SI level and also the SoI level.

In accordance with an embodiment, the method 1300 further comprises an exploitation stage including the steps of computing a phase shift configuration ϕ_{d} for each digitally controllable scatterer d in the subset dᵢ, taking into account a constraint defined for a target residual self-interference level at the receiver unit 110. The phase shift configuration ϕ_{d} for each DCS d, in the subset dᵢ is computed. The computation of the phase shift configuration ϕ_{d} takes into account the constraint defined for the target residual SI level after propagation domain mitigation at the receiver unit 110.

The method 1300 further comprises computing TX and RX beamformers at the full duplex node 102 taking into account the computed phase response of each digitally controllable scatterer in the subset dᵢ, and the target residual self-interference level Tsj. The computation of the TX beamformer resulting in the TX beam 112 also includes computation of transmission power of the FD node 102, or allowed TX power range, optimization of low noise amplifier (LNA) gain and sensitivity with TX power optimization, such that the constraint on the target residual SI level T_{SI} after propagation domain mitigation is met. The target SoI levels may also be considered for design of the TX beam 112 and the RX beam 114.

The method 1300 further comprises updating channel state information based on the computed phase shift configuration ϕ_{d}. The computed phase shift configuration ϕ_{d} results in a new propagation channel (i.e., the propagation channel via a DCS is modified if the DCS's phase response is modified) hence, the channel state information (CSI) can be updated accordingly.

The method 1300 further comprises deciding based on the updated channel state information if digitally controllable scatterers should be removed from the subset dᵢ and if so, updating the subset dᵢ to exclude those digitally controllable scatterers. If any DCS is removed from the subset dᵢ on the basis of the computed phase shift configuration ϕ_{d}, or resulting TX and RX beams, or updated channel state information, or SI level or SoI level then the subset dᵢ can be updated after removing the DCS from the subset dᵢ.

The method 1300 further comprises informing other entities in the system about the subset dᵢ. The other entities in the system are informed about other DCSs that are not in the subset dᵢ and are available for other communication.

In accordance with an embodiment, the subset dᵢ is obtained by choosing a set of digitally controllable scatterers that result in a residual self-interference power P_{SI} at the full duplex node 102 that is lower than or equal to the target residual level T_{SI}. The subset dᵢ is obtained by choosing the set of DCSs that result in the residual self-interference power P_{SI} at the full duplex node 102 that is lower than or equal to the target residual level T_{SI}, as have been described in detail, for example, in FIGS. 4B-4E and 5.

In accordance with an embodiment, the subset dᵢ can be obtained by considering a SINR given by P_{SoI}/P_{SI} where P_{SoI} is the power of the signal of interest incoming at the full duplex node 102 or the full duplex node's intended receiver and P_{SI} is the target residual power level. The subset dᵢ can be obtained by considering the SINR given by P_{SOI}/P_{SI}, as have been described in detail, for example, in FIG. 4E.

In accordance with an embodiment, the method 1300 further includes communication between a first full duplex node (e.g., the first full duplex node 602) and a second full duplex node (e.g., the second full duplex node 604), the assessment stage including for the first full duplex node (i.e., the first full duplex node 602) identifying an initial first set of potential digitally controllable scatterers to be used in communication, and for the second full duplex node (i.e., the second full duplex node 604), identifying an initial second set of potential digitally controllable scatterers to be used in communication, assessing the residual self-interference levels for one or more potential configurations of the digitally controllable scatterers in the initial first set and initial second set and selecting, based on the assessments of residual self-interference levels, a first subset d₁ of digitally controllable scatterers for the first full duplex node (i.e., the first full duplex node 602) and a second subset d₂ of digitally controllable scatterers for the second full duplex node (i.e., the second full duplex node 604), wherein subsets d₁ and d₂ are disjoint for one or more possible configurations of the first and second subsets, the method 1300 including in the exploitation stage computing phase shift configuration ϕ_{d} for digitally controllable scatterer d∈dᵢ and DCS d∈d₂. An implementation scenario of the method 1300 that includes communication between the first full duplex node and the second full duplex node is described in detail, for example, in FIGS. 6A-6C, 7 and 8.

In accordance with an embodiment, the full duplex node (e.g., the full duplex node 902) is arranged to communicate with a base station (e.g., the base station 908) and a user equipment (e.g., the UE 910), wherein the association stage is implemented by solving an optimization problem set up to assess the residual self-interference power level and the received power of the signal of interest P_{SoI}, according to the following Equation:

$${d}_{i} = arg {max}_{d ⊆ \{ 1 , … , D \} \vert {P}_{SI} ( d ) \leq {T}_{SI}} {P}_{SoI} ( d )$$

and the exploitation stage is implemented by solving an optimization problem according to the following Equation:

$$\{ {ϕ}_{d}^{*} , {V}^{*} , {U}^{*} \} = arg {max}_{{ϕ}_{d ∀ d ∈ {d}_{i} ,} , V , U} {P}_{SoI} ( {ϕ}_{d} , V , U )$$

$$s . t . {P}_{SI} \leq {T}_{SI} .$$

An implementation scenario of the method 1300 that includes communication between the FD node, the base station and the UE is described in detail, for example, in FIGS. 9A-9E, 10, 11 and 12.

In accordance with an embodiment, the full duplex node (e.g., the full duplex node 902) can be associated with a base station (e.g., the base station 908) and a user equipment (e.g., the UE 910), and, wherein the association stage can be implemented by solving an optimization problem set up to minimize the residual self-interference power level while meeting a constraint on the target SINR at the full duplex node (e.g., the full duplex node 902), wherein the SINR is assessed by computing P_{SoI}/P_{SI} where P_{SoI} is the power of the signal of interest incoming at the full duplex node (e.g., the full duplex node 902) and P_{SI} is the residual SI power level, and the exploitation stage can be implemented by solving an optimization problem set up to compute the phase response for each digitally controllable scatterer in the subset dᵢ and compute the beams for TX and RX so that the residual self-interference power level is minimized while meeting the constraint on the target SINR. An implementation scenario of the method 1300 that includes communication between the FD node, the base station and the UE is described in detail, for example, in FIGS. 9A-9E, 10, 11 and 12.

The steps 1302 to 1308 are only illustrative and other alternatives can also be provided where one or more steps are added, one or more steps are removed, or one or more steps are provided in a different sequence without departing from the scope of the claims herein.

In one aspect, a computer program product comprising computer-readable code means which when run in a control unit (e.g., the control unit 106) arranged to control a full duplex node (e.g., the full duplex node 102) and optionally one or more digitally controllable scatterers, will cause the full duplex node (i.e., the FD node 102) to perform the method 1300. In another aspect, the computer program product comprising a non-transitory storage medium on which the computer-readable code means are stored.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1. A control unit for use in a wireless communication network, the wireless communication network including a full duplex node and one or more digitally controllable scatterers, said full duplex node including a transmitter unit and a receiver unit, the transmitter unit and the receiver unit being coupled in such a way that a transmitted signal will generate a residual self-interference at the receiver unit, the control unit comprising:
an assessing unit for identifying an initial set of potential digitally controllable scatterers to be used in the wireless communication network, and for one or more digitally controllable scatterers in the initial set, assessing a level of the resulting residual self-interference for one or more potential configurations of the digitally controllable scatterer, each potential configuration including one or more digitally controllable scatterers, or being an empty set, and
an identifying unit for identifying a subset dᵢ of the initial set of digitally controllable scatterers to be associated with the full duplex node i, based on the assessments of residual self-interference levels for the one or more potential configurations, and
a digitally controllable scatterers control unit for providing information required for configuring the digitally controllable scatterers in the subset dᵢ.

2. The control unit of claim 1, further comprising
a first computing unit for computing a phase shift ϕ_{d} for each digitally controllable scatterer d, in the subset dᵢ, taking into account a constraint defined for a target residual self-interference level at the receiver unit,
a second computing unit for computing a transmitter beamformer for generating a transmitter beam and a receiver beamformer for generating a receiver beam at the full duplex node taking into account the computed phase response of each digitally controllable scatterer in the subset dᵢ, and the target residual self-interference level T_{SI},
an updating unit for updating channel state information based on the computed phase shifts ϕ_{d}
a decision unit for deciding based on the updated channel state information if any digitally controllable scatterer should be removed from the subset dᵢ and if so, updating the subset dᵢ to exclude that digitally controllable scatterer,
an information unit for informing other entities in the wireless communication network about the subset dᵢ.

3. The control unit according to claim 1, further arranged to control the digitally controllable scatterers in the subset dᵢ.

4. The control unit according to claim 1, wherein the assessing unit is arranged to assess the level of the resulting residual self-interference based on the location of the digitally controllable scatterer and/or a characteristic of a beacon associated with the digitally controllable scatterer.

5. An entity for use in a wireless communication network, wherein the wireless communication network including a full duplex node and one or more digitally controllable scatterers, said full duplex node including a transmitter unit and a receiver unit, the transmitter unit and the receiver unit being coupled in such a way that a transmitted signal will generate a residual self-interference at the receiver unit, said entity being one of a full duplex node, a base station, an access point or a digitally controllable scatterer, said entity comprising a control unit, wherein the control unit comprising:
an assessing unit for identifying an initial set of potential digitally controllable scatterers to be used in the wireless communication network, and for one or more digitally controllable scatterers in the initial set, assessing a level of the resulting residual self-interference for one or more potential configurations of the digitally controllable scatterer, each potential configuration including one or more digitally controllable scatterers, or being an empty set, and
an identifying unit for identifying a subset dᵢ of the initial set of digitally controllable scatterers to be associated with the full duplex node i, based on the assessments of residual self-interference levels for the one or more potential configurations, and
a digitally controllable scatterers control unit for providing information required for configuring the digitally controllable scatterers in the subset dᵢ.

6. A method in a wireless communications network including a full duplex node and one or more digital controllable scatterers, wherein the full duplex node comprises a full duplex node including a transmitter unit and a receiver unit, the transmitter unit and the receiver unit being coupled in such a way that a transmitted signal generates a residual self-interference at the receiver unit, the method comprising an assessment stage including the steps of:
identifying an initial set of potential digitally controllable scatterers to be used in the wireless communications network,
for one or more digitally controllable scatterers in the initial set, assessing a resulting residual self-interference level at the full duplex node for one or more potential configurations of the digitally controllable scatterers, each potential configuration including one or more digitally controllable scatterers, or being an empty set,
identifying a subset dᵢ of the initial set of digitally controllable scatterers to be associated with the full duplex node i, based on the assessments of residual self-interference levels for the one or more potential configurations,
providing information required for configuring the digitally controllable scatterers in the subset dᵢ.

7. The method of claim 6, further comprising an exploitation stage including the steps of computing a phase shift ϕ_{d} for each digitally controllable scatterer d in the subset dᵢ, taking into account a constraint defined for a target residual self-interference level at the receiver unit,
computing TX and RX beamformers at the full duplex node taking into account the computed phase response of each digitally controllable scatterer in the subset dᵢ, and the target residual self-interference level T_{SI},
updating channel state information based on the computed phase shifts ϕ_{d},
deciding based on the updated channel state information if digitally controllable scatterers should be removed from the subset dᵢ and if so, updating the subset dᵢ to exclude those digitally controllable scatterers,
informing other entities in the wireless communications network about the subset dᵢ.

8. The method according to claim 6, wherein the initial set is selected based on the distance between the digitally controllable scatterers and the full duplex node.

9. The method according to claim 6, wherein the step of assessing the level of self-interference is performed based on the location of the digitally controllable scatterer and/or a characteristic of a beacon associated with the digitally controllable scatterer.

10. The method according to claim 6, wherein the subset dᵢ is obtained by choosing a set of digitally controllable scatterers that result in a residual self-interference power P_{SI} at the full duplex node that is lower than or equal to the target residual level T_{SI}.

11. The method according to claim 6, wherein the subset dᵢ is obtained by considering a SINR given by P_{SoI}/P_{SI} where P_{SoI} is the power of the signal of interest incoming at the full duplex node or the full duplex node's intended receiver and P_{SI} is the target residual power level.

12. The method according to claim 6, involving communication between a first full duplex node and a second full duplex node, the assessment stage including for the first full duplex node identifying an initial first set of potential digitally controllable scatterers to be used in communication, and for the second full duplex node, identifying an initial second set of potential digitally controllable scatterers to be used in communication, assessing the residual self-interference levels for one or more potential configurations of the digitally controllable scatterers in the initial first set and initial second set and selecting, based on the assessments of residual self-interference levels, a first subset d₁ of digitally controllable scatterers for the first full duplex node and a second subset d₂ of digitally controllable scatterers for the second full duplex node, wherein subsets d₁ and d₂ are disjoint for one or more possible configurations of the first and second subsets, the method including in the exploitation stage computing phase shift ϕ_{d} for digitally controllable scatterer d∈dᵢ and DCS d∈d₂.

13. The method according to claim 6, wherein the full duplex node is arranged to communicate with a base station and a user equipment, wherein the association stage is implemented by solving an optimization problem set up to assess the residual self-interference power level and the received power of the signal of interest P_{SoI}, according to the following equation:
$${d}_{i} = arg {max}_{d ⊆ \{ 1 , … , D \} \vert {P}_{SI} ( d ) \leq {T}_{SI}} {P}_{SoI} ( d )$$
and the exploitation stage is implemented by solving an optimization problem according to the following equation:
$$\{ {ϕ}_{d}^{*} , {V}^{*} , {U}^{*} \} = arg {max}_{{ϕ}_{d ∀ d ∈ {d}_{i} ,} , V , U} {P}_{SoI} ( {ϕ}_{d} , V , U )$$
$$s . t . {P}_{SI} \leq {T}_{SI} .$$

14. The method according to claim 6, wherein the full duplex node is associated with a base station and a user equipment, and, wherein the association stage is implemented by solving an optimization problem set up to minimize the residual self-interference power level while meeting a constraint on the target SINR at the full duplex node, wherein the SINR is assessed by computing P_{SoI}/P_{SI} where P_{SoI} is the power of the signal of interest incoming at the full duplex node and P_{SI} is the residual SI power level, and the exploitation stage is implemented by solving an optimization problem set up to compute the phase response for each digitally controllable scatterer in the subset dᵢ and compute the beamformers for TX and RX so that the residual self-interference power level is minimized while meeting the constraint on the target SINR.

15. A non-transitory computer-readable storage medium comprising instructions which when run in a control unit arranged to control a full duplex node and optionally one or more digitally controllable scatterers in a wireless communications network, will cause the full duplex node to perform steps of:
identifying an initial set of potential digitally controllable scatterers to be used in the wireless communications network,
for one or more digitally controllable scatterers in the initial set, assessing a resulting residual self-interference level at the full duplex node for one or more potential configurations of the digitally controllable scatterers, each potential configuration including one or more digitally controllable scatterers, or being an empty set,
identifying a subset d_i of the initial set of digitally controllable scatterers to be associated with the full duplex node i, based on the assessments of residual self-interference levels for the one or more potential configurations,
providing information required for configuring the digitally controllable scatterers in the subset d_i.
